(19) United States
(12) Patent Application Publication
(10) Pub. No.: US 2006/0280317 A1
(43) Pub. Date: Dec. 14, 2006

(54) Cascading multi-band frequency notch filter

(76) Inventor: John G. Panulas, Stamford, CT (US)

Correspondence Address: ST. ONGE STEWARD JOHNSTON & REENS, LLC, 986 BEDFORD STREET, STAMFORD, CT, 06905-5619, US

(21) Appl. No.: 11/441,211

(22) Filed: May 25, 2006

Related U.S. Application Data
(60) Provisional application No. 60/684,390, filed on May 25, 2005.

(51) Int. Cl. H04B 15/00

(52) U.S. Cl. 381/94.1

(57) ABSTRACT

An audio filter system including an audio notch filter having selected resistance and capacitance values, the system including up to ten parallel connected notch filters for a filter set, each notch filter selected to notch the same frequency or band of frequencies. A number of filter sets may further be connected to each other to notch or reject numerous different frequencies or band of frequencies as required by the application. The system filtering out frequencies and frequency bands not necessary for faithful reproduction of the original audio signal so as to substantially eliminate various forms of distortion, sideband loading and heterodyning.

### CROSS-REFERENCE TO RELATED APPLICATIONS

This application claims the benefit of the filing date of U.S. Provisional Patent Application Ser. No. 60/684,390 filed May 25, 2005.

### FIELD OF THE INVENTION

The invention relates to a filtering circuit for audio filtering, and in particular relates to an electronic filter array used in conditioning audio signals.

### BACKGROUND OF THE INVENTION

Audio signal conditioning presents a number challenges especially for radio broadcast applications. For example, it is desirable to broadcast audio signals as close to actual live sound as possible, however, various types of distortion and interference due to equipment limitations and environmental factors can have a negative effect on the audio signal.

Accordingly, many types of audio filters have been used with varying levels of success to provide filtering of audio signals. For example, audio notch filters have been used to filter out particular frequencies known to cause problems with the audio signal. A major challenge faced by audio engineers is to provide filtering of specific (often relatively narrow) frequency bands of an audio signal, for example in dealing with sideband distortion, while not attenuating the surrounding frequencies or overall signal. To illustrate the challenge, some tones reside at a frequency that is quite isolated from other tones. Because these tones are isolated, filtering is relatively simple because there are no surrounding tones that will be affected. However, other tones are substantially bunch together, which requires any filtering to be very precise so as not to attenuate the surrounding frequencies and thereby negatively affect sound quality.

Ganged amplification and other devices create additional challenges in presenting a high degree of detailed signal clarity, intelligibility and resonance. Finally, providing many different types of filters that have a substantially constant or steady resistance so as not to negatively affect overall sound quality is also difficult.

Another design criterion that radio broadcast stations must consider are the regulations propagated by the Federal Communications Commission (FCC), which has provided guidelines within, which the station must operate. One such guideline limits the usable audio frequencies of the broadcast station so that the audio signal from one station does not “spill over” into the frequency range allotted to a different station. The need to comply with these regulations has led to the use of filters for attenuating frequencies to comply with FCC criteria, effectively narrowing the total useable frequency band available to the broadcast station. For example, the broadcast station may be allotted a frequency band within which to operate. In order to maintain the audio signals within that particular range, the station may need to limit their audio broadcast signal by means of filters, to a narrower subset of the allotted frequency band to ensure compliance.

Still another regulation the radio station must consider is peak limiting. So-called “multi-function boxes”, while providing peak limiting, have been used, which have the net effect of distorting the signal by deliberate clipping, limiting, unnecessary roll-off of passed frequencies essential to faithful reproduction of source material, and resultant reduction in directionality of a multi-channel signal.

What is needed then is a filter system and method which provides audio signal conditioning on an integrated basis across an extremely wide range of frequencies that substantially eliminates distortion and maximizes resonance per frequency.

It is further desired to provide a filter system and method which provides for audio signal filtering accounting for amplitude considerations but still enhancing frequency quality.

It is still further desired to provide a filter system and method which provides for elimination not only of harmonic distortion, but also of distortions occurring within and across octaves.

It is yet further desired to provide a filter system and method which provides independent of amplitude levels, concomitant articulate musical instrument attacks, natural/open resolution of consonants and vowels in speech and overall presence approaching a free space condition, free of an electronic device.

### SUMMARY OF THE INVENTION

These and other objectives are achieved in one advantageous embodiment by the provision of an audio filter, and more specifically to an array of audio notch filters in various configurations that provides audio filtering of multiple audio frequency bands. The various selected configurations allow for minimizing and/or substantial elimination of harmonic distortion in selected audio frequency bands in audio signal recording, transmission and broadcasting.

In one advantageous embodiment, a voltage-controlled source active band-reject filter (notch filter) is utilized. A plurality of such filters may be provided in series, providing a cascading chain of filters. In one embodiment, a cascade of up to ten filters may be used for audio filtering in each band. These groups of filters for each band are preferably positioned in series, with successive groups of filters filtering the selected bands. It is, however, possible for the groups of filters to be parallel connected. The notch filters will advantageously be selected/constructed to have a substantially constant or steady resistance relative to other notch filters in the circuit. The notch filters may, however, having varied capacitance values.

The voltage-controlled source active band-reject filter is configured as a combination of resistance and capacitance, cascaded for example, ten times per band and functions as an integrative device. It provides a cut grater than 200 db (−200 db) approaching −300 db per frequency band, over relatively narrow bands within an overall range of approximately 0.25 cycles per second (cps) to as many as 2 petacycles per second (pcps).

A practical advantage of the present filter system is its ability to effectively eliminate the boundaries to obtaining high clarity and resonance due to, for example, ganged amplification and/or other devices where regulatory bandwidth constraints and commercial requirements either cannot be reconciled with or serve to defeat these qualities. In particular, the filter system relieves sideband load and at a minimum, reduces the need for peak limiting. The filter system further eliminates the need for so-called “multi-function boxes.” This is achieved by not only eliminating distortion, but also by maximizing resonance per frequency. Consistent with this, the emphasis is shifted away from mere amplitude considerations in commercial environments to consideration of frequency quality.

Still further, the filter system provides for elimination of distortions occurring within and across octaves such as for example: dominant, tonic, subdominant, mediant and leading tones heterodyning against each other, thereby producing substantially pure resonance per tone, which is accomplished independent of amplitude levels.

A further aspect of the invention is the identification and selection of numerous (e.g. 130 or more) relatively narrow frequency bands to be filtered within the overall frequency range of from approximately 20 cycles per second (cps) to approximately 43,000 cps to provide the best acoustical output from a system using a cascading audio notch filter. In this manner, the system may clearly reproduce material down to amplitudes as low as 3 decibels on playback.

It should be noted that, the terms “coupled”, “coupled to”, and “coupled with” as used herein each mean a relationship between or among two or more devices, apparatus, files, programs, media, components, networks, systems, subsystems, and/or means, constituting any one or more of (a) a connection, whether direct or through one or more other devices, apparatus, files, programs, media, components, networks, systems, subsystems, or means, (b) a communications relationship, whether direct or through one or more other devices, apparatus, files, programs, media, components, networks, systems, subsystems, or means, and/or (c) a functional relationship in which the operation of any one or more devices, apparatus, files, programs, media, components, networks, systems, subsystems, or means depends, in whole or in part, on the operation of any one or more others thereof.

In one advantageous embodiment a filter system for filtering an audio signal is provided comprising an audio input signal and a plurality of notch filters. Each notch filter has an input terminal, with each input terminal electrically connected to each other, and each notch filter has an output terminal, with each output terminal electrically connected to each other. The system is provided such that the plurality of notch filters has selected resistance and capacitance values corresponding to a frequency to be attenuated. The system is further provided such that each of the parallel connected notch filters has the same selected resistance and capacitance values so as to attenuate the same frequency.

In another advantageous embodiment a filter system for filtering an audio signal including a plurality of parallel connected notch filters each of said plurality of filters having an input terminal is provided and comprises a capacitor (C₁) electrically connected to the input terminal and a capacitor (C₂) electrically connected to capacitor (C₁), the capacitor (C₂) being electrically connected to a non-inverting input of an operational amplifier. The system further comprises a resistor (R₁) electrically connected to the input terminal and a resistor (R₂) electrically connected to resistor (R₁), the resistor (R₂) electrically connected to the non-inverting input of the operational amplifier. The system still further comprises a capacitor (C₃) electrically connected to a point between resistor (R₁) and resistor (R₂) and a ground connection and a resistor (R₃) electrically connected to a point between capacitor (C₁) and capacitor (C₂) and the inverting input of the operational amplifier.

In still another advantageous embodiment a filter system for filtering an audio signal is provided comprising a plurality of notch filters each of the plurality of filters having an input terminal and an output terminal. The system is provided such that the input terminals of the plurality of notch filters electrically are connected to each other and the output terminal of the plurality of notch filters are electrically connected to each other. The system is further provided such that the plurality of notch filters each have selected resistance and capacitance values selected from Table A corresponding to a frequency to be attenuated, and each of the parallel connected notch filters have the same selected resistance and capacitance values so as to attenuate the same frequency.

In yet another advantageous embodiment a filter system for filtering an audio signal is provided comprising a plurality of parallel connected notch filters having selected resistance and capacitance values corresponding to a frequency to be attenuated. The system is provided such that each of the parallel connected notch filters has the same selected resistance and capacitance values so as to attenuate the same frequency.

In still another advantageous embodiment a method for filtering an audio signal is provided comprising the steps of identifying a bandwidth of audio frequencies and identifying a plurality of frequency bands within the bandwidth of audio frequencies. The method further comprises the steps of electrically connecting a plurality of sets of audio filters in series and inputting the audio signal into the plurality of sets of audio filters. The method still further comprises the steps of attenuating all the frequencies in the bandwidth of audio frequencies except for the identified plurality of frequency bands and outputting the filtered audio signal from the plurality of sets of audio filters.

Other objects of the invention and its particular features and advantages will become more apparent from consideration of the following drawings and accompanying detailed description.

### BRIEF DESCRIPTION OF THE DRAWINGS

FIG. 1 is a block diagram of an advantageous embodiment of filter system.

FIG. 2 is schematic diagram illustrating one advantageous embodiment of a filter used in the filter system according to FIG. 1.

### DETAILED DESCRIPTION OF THE INVENTION

Referring now to the drawings, wherein like reference numerals designate corresponding structure throughout the views.

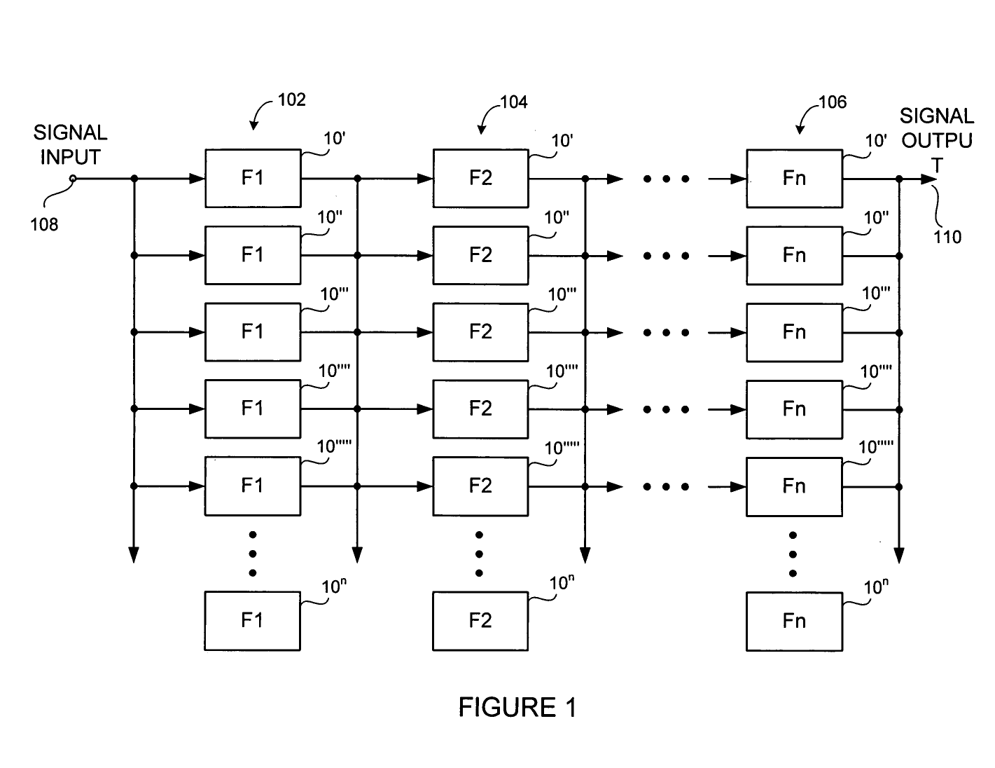

Filter system 100 is illustrated in FIG. 1. Conceptually, filter system 100 may be expressed mathematically in the following iterative algorithm (iterative because of the necessity to take account of the differing multiple topologies of media that may be encountered en route to the final filtration),
FDₙ₊₁=Dₙ((Dₙ₊₁−Dₙ)/Dₙ) Formula 1
where, FDₙ₊₁ is the final density value, Dₙ is the initial density value (density in the first medium), and Dₙ₊₁ is the next density value (density in the next medium and on an iterative basis, successive media).

An important general relationship reflected in formula 1 is the difference between two groups of frequencies; 1) those frequencies whose tones reflect very high “atomistic” densities, comparatively high spectral Q values and distinct, isolated, highly concentrated/cohesive “elemental” domains, and 2) those whose densities and Q values necessarily and variably depend on molecular fusions, structures and geometries of diffuse matter endemic to their part of the energy bandwidth and the medium/dielectric through which they pass. Frequencies in the second group coalesce as the net result of absorptive and reflective processes and are found primarily within the approximately middle fifty percent of each octave of sound, light and other forms of energy.

For purposes of further illustration, using values provided in Table A, Formula 2 should be applied for computations above 43,000 cps, while Formula 3 should be applied for computations below 20 cps:
2^{x}(t_{ef}−T_{ef-1})=BWᵣₑⱼ Formula 2
0.5^{x}(T_{ef}−Te_{f-1})=BWᵣₑⱼ Formula 3

Where, x is the octave raised (or lowered below 20 cps), T_{ef} is the center frequency (cf) first considered, T_{ef-1} is the next lower frequency below cf, and BWᵣₑⱼ is the rejected bandwidth.

Referring again to FIG. 1, filter system 100 generally comprises a first filter set 102, including, for example, up to ten parallel connected filters (F1) 10′, 10″, 10′″ . . . 10ⁿ. Filter system 100 further comprises a second filter set 104, also including, for example, up to ten parallel connected filters (F2) 10′, 10″, 10′″ . . . 10ⁿ. Finally, another filter set 106 including, for example, up to ten parallel connected filters (Fn) 10′, 10″, 10′″ . . . 10ⁿ is shown. While it is contemplated that ten parallel connected filters for each group is a preferred embodiment, it is contemplated that more or fewer filters may be used in each filter group as desired and such is indicated by the three dots extending between, for example, filter (F1) 10′″″ and filter (F1) 10ⁿ. Additionally, virtually any number of filters groups may be used depending upon the particular frequencies to be filtered and the application.

The configuration of filter system 100 therefore, typically comprises a number of parallel connected filters 10′, 10″, 10′″ . . . 10ⁿ, which forms a filter set, each individual filter selected to filter out the same frequency or band of frequencies. Any number of filter sets may preferably be connected in series, however, it is contemplated that filter sets may also be connected in parallel.

Accordingly, filter system 100 includes a signal input 108 where an audio signal may be introduced to the filter system. In the advantageous embodiment illustrated in FIG. 1, the audio signal will then encounter the first filter set 102, which will filter out a frequency, and more specifically, a band of frequencies based upon the selected resistance and capacitance values for filter (F1).

Filter (F1) 10′, 10″, 10′″ . . . 10ⁿ are all designed substantially identically, so as to provide superior filtering of the frequency or band of frequencies to be removed from the audio signal. In this manner, as steeper notch is attainable, this will help to minimize side band distortion. The sets of filters may then be connected to each other (whether in series as shown, or in parallel) with the total number of filter sets used corresponding to the frequencies or band of frequencies to be attenuated.

Finally, the filtered audio signal exits filter system 100 as signal output 110, which will be a filtered signal that still contains very high signal quality.

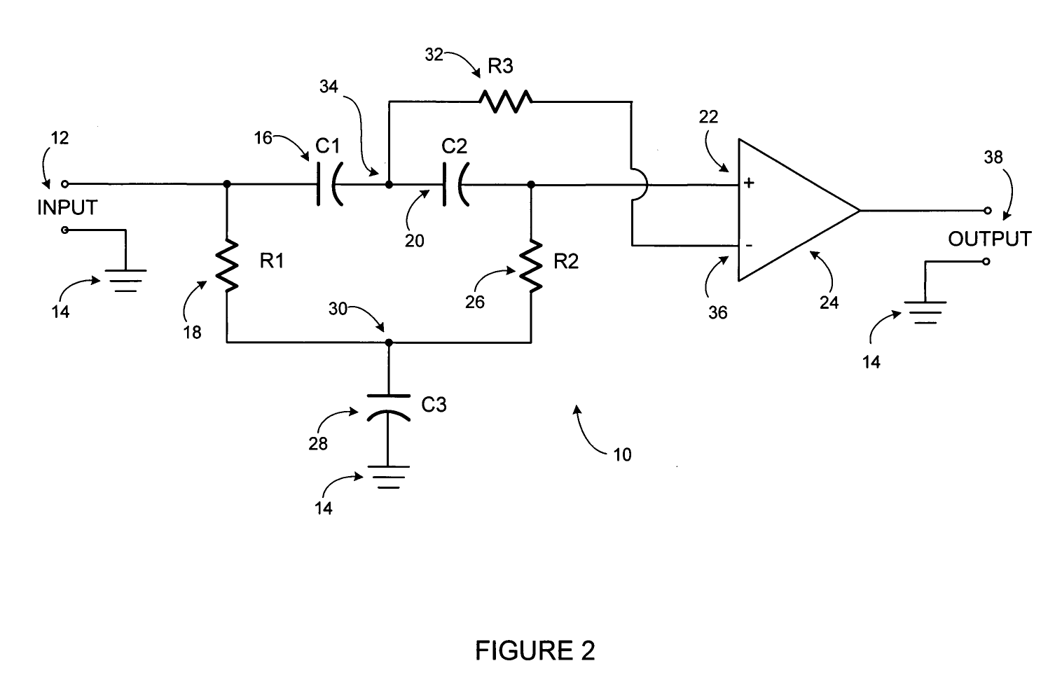

Referring now to FIG. 2, an advantageous embodiment of the present invention is illustrated for a configuration of the filter 10′, 10″, 10′″ . . . 10ⁿ. The filter (10) includes an input 12, which in the configuration shown in FIG. 1, will be connected to each of the other filter inputs (12). The filter input 12 is provided with a ground reference 14.

The filter (10), in this advantageous embodiment, is constructed as follows. Input 12 is electrically connected to both capacitor (C1) 16, and resistor (R1) 18. Capacitor (C1) is further electrically connected to capacitor (C2) 20, which in turn is electrically connected to the non-inverting input 22 of operational amplifier 24. Resistor (R1) 18 is electrically connected to resistor (R2) 26, which is also electrically connected to the non-inverting input 22 of operational amplifier 24. In this manner, resistors (R1) and (R2) are electrically connected in parallel with capacitors (C1) and (C2) from input 12 to the non-inverting input 22 of operational amplifier 24.

Also shown in FIG. 2 is capacitor (C3) 28, which is electrically connected to a point 30 between resistors (R1) and (R2). Capacitor (C3) is also electrically connected to ground 14.

Still further, as seen in FIG. 2, resistor (R3) 32 is electrically connected to a point 34 between capacitors (C1) and (C2). Resistor (R3) 32 is electrically connected to the inverting input 36 of operational amplifier 24.

The filtered signal is then output from operational amplifier 24 at output 38. It should be noted that, each output 38 of each filter 10 in a given filter set will be electrically connected to each other such that each filter in a filter set are parallel connected.

The values of resistors (R1) (R2) (R3) and of capacitors (C1) (C2) (C3), will determine the frequency or band of frequencies the filter 10 will notch or reject.

As the selection of these values will determine the accuracy of the filter 10, a Table A is provided, which provides various values for the resistors and the capacitors and shows a corresponding frequency or band of frequencies that will accordingly be rejected. The Table A is provided to be read across.

For example, in referring to Table A 1-1 through 1-3, the right hand column illustrates a desired notch frequency range to be filtered in bold between two horizontal lines (for example, in the first entry in Table A on page 1-1, the filtered frequency range is 20.83659 to 20.96074 cps). Additional information if provided including the bandwidth corresponding to 0.12415 cps, with the notch center frequency (CF) being 20.898665 cps. Various values are provided as read across the table including, for example, the system sharpness or quality (Q), conductance, and frequency normalization value (u), which is calculated as 6.28×(CF). Also provided is, for example, impedance scaling value (ISF), which is calculated as (CF)/62.8.

Also shown are the values for capacitors and resistors in Table A on page 1-2. In this example, capacitor (C1) is selected to be approximately 0.022896174 F, capacitor (C2) is selected to be approximately 0.022896174 F, and capacitor (C3) is selected to be approximately 0.045792347 F. Additionally, resistor (R1) is selected to be approximately 0.000988455Ω, resistor (R2) is selected to be approximately 112.0368054Ω, and resistor (R3) is selected to be approximately 0.000988447Ω. Further circuit information is provided in Table A from pages 1-2 through 1-3.

It should be noted that, while various functions and methods have been described and presented in a sequence of steps, the sequence has been provided merely as an illustration of one advantageous embodiment, and that it is not necessary to perform these functions in the specific order illustrated. It is further contemplated that any of these steps may be moved and/or combined relative to any of the other steps. In addition, it is still further contemplated that it may be advantageous, depending upon the application, to utilize all or any portion of the functions described herein.

This was merely provided as an example of one configuration of filter 10 according to Table A. As seen in Table A, a relatively large number of notch frequencies are listed having corresponding values provided for the various capacitors and resistors in addition to providing various overall circuit information. While Table A is relatively large, it is not meant to be comprehensive and should not be taken as limiting in any regard, but merely provides circuit design information for particularly troublesome frequencies that typically are required to be filtered out of an audio frequency. It is contemplated that fine-tuning of each system may need to be accomplished, however, the formulas provided herein along with Table A will provide a guidance to one seeking to notch out a particular frequency or band of frequencies not listed in Table A. Accordingly, while a great deal of information is listed in Table A, it is contemplated that additional frequency bands may further need to be removed from the audio signal and such can be done without deviating from the invention.

It is further contemplated that the filter system 100 may be provided in, for example, a hermetically sealed protective housing to protect the relatively sensitive electronic equipment from harsh environmental conditions. The housing may be provided has a sturdy structure comprising, for example, a hard plastic, metal, an alloy or combinations thereof.

Although the invention has been described with reference to a particular arrangement of parts, features and the like, these are not intended to exhaust all possible arrangements or features, and indeed many other modifications and variations will be ascertainable to those of skill in the art.

TABLE A 1

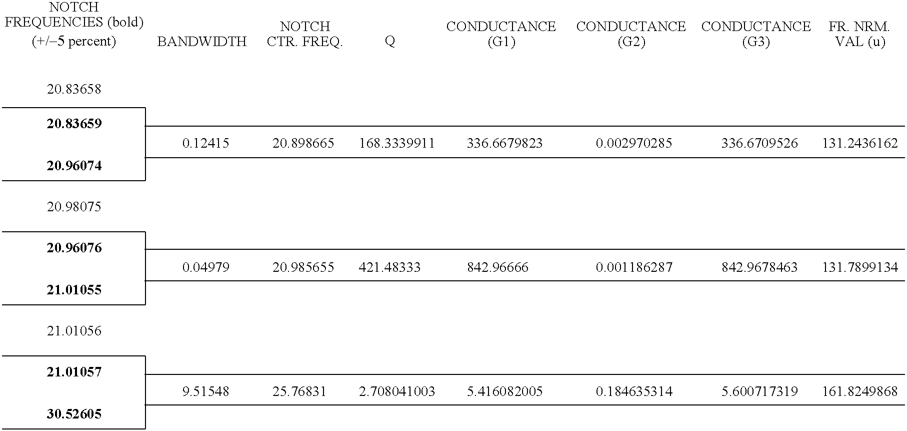

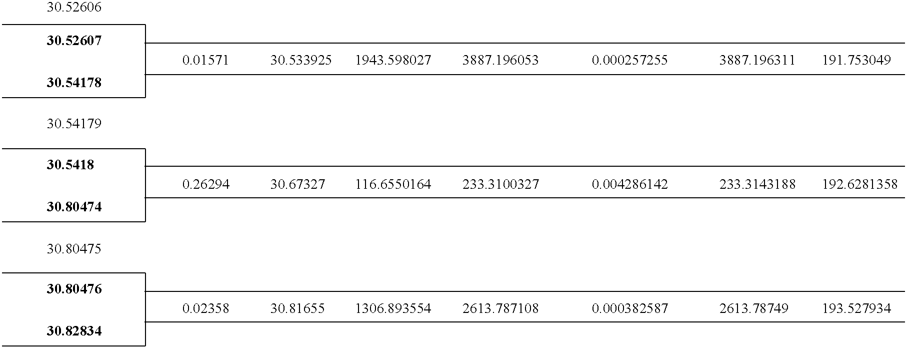

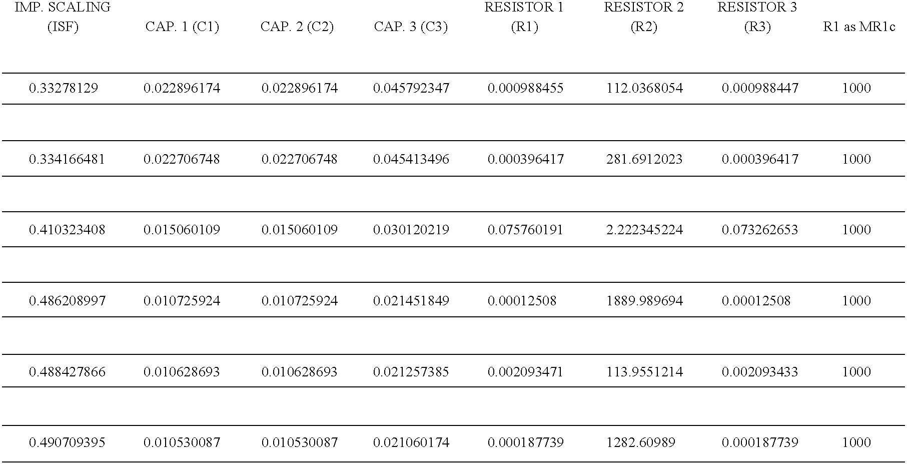

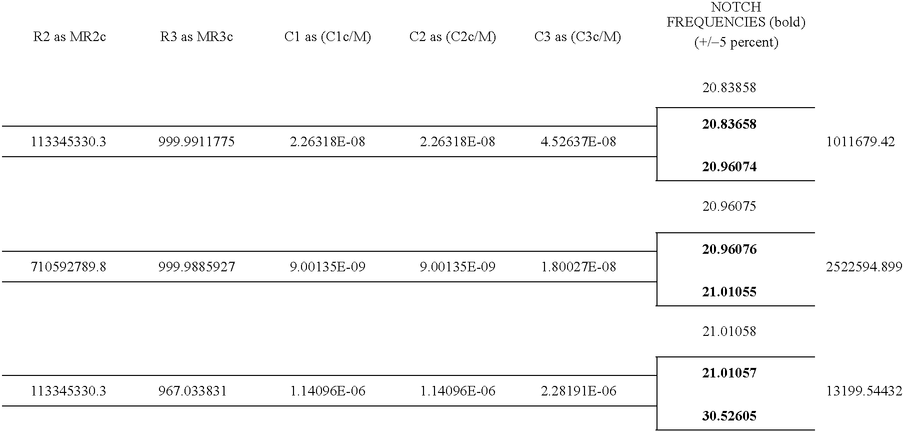

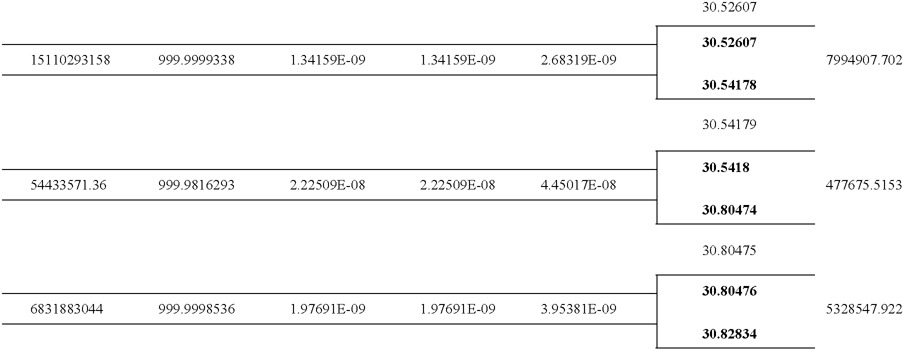

TABLE A 2

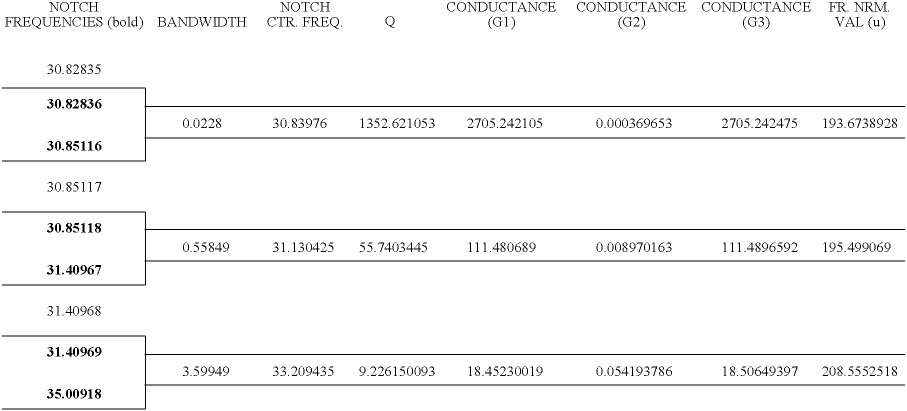

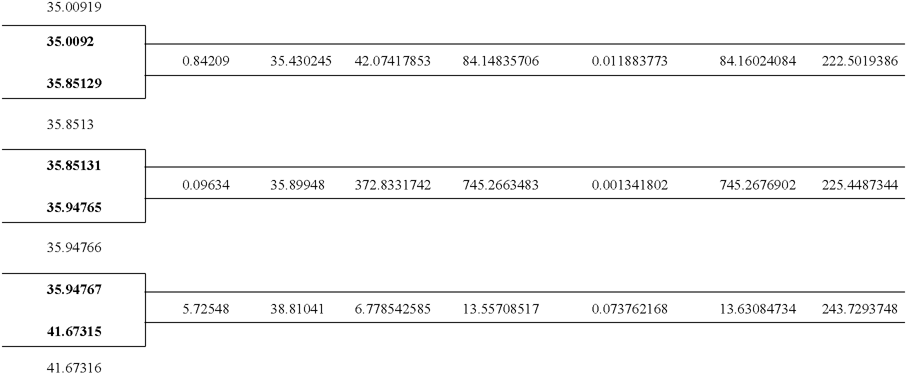

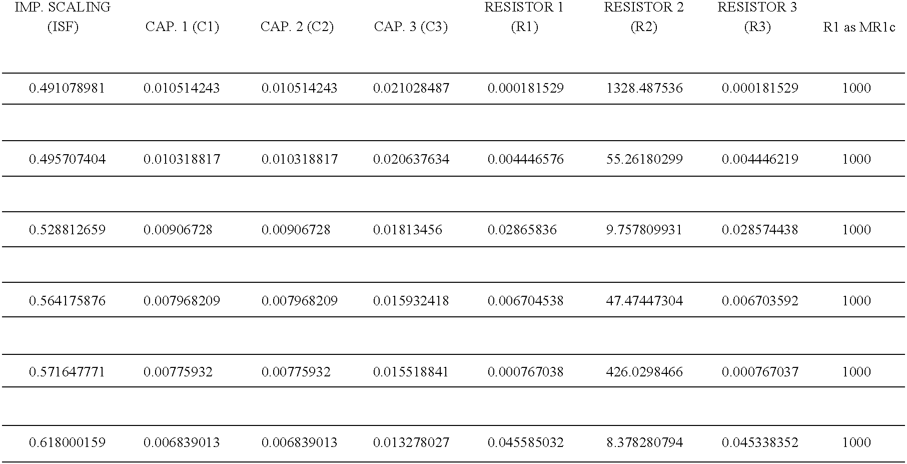

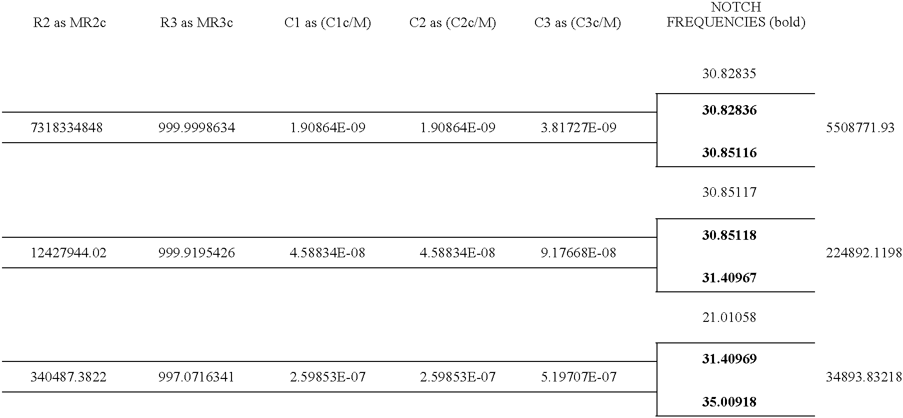

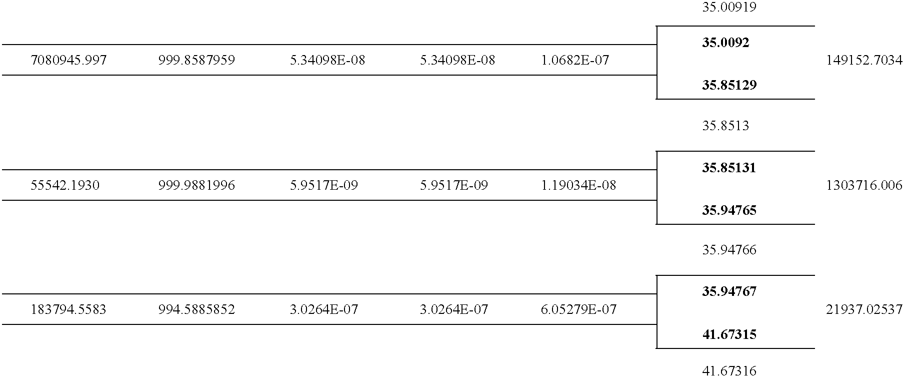

TABLE A 3

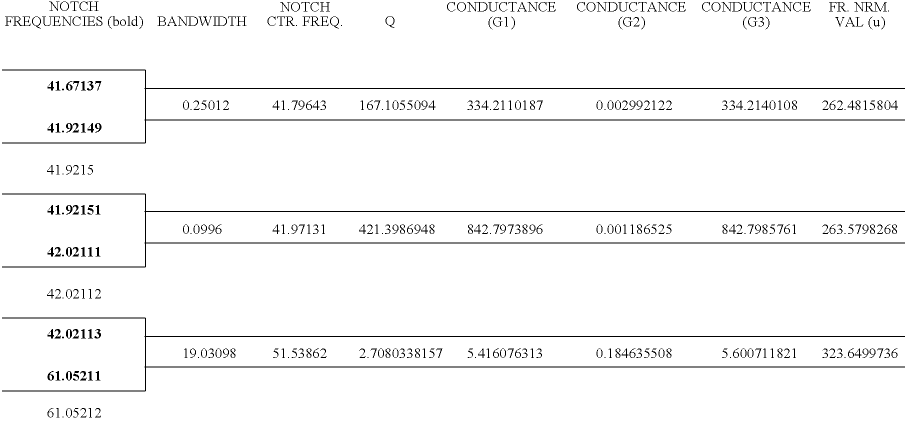

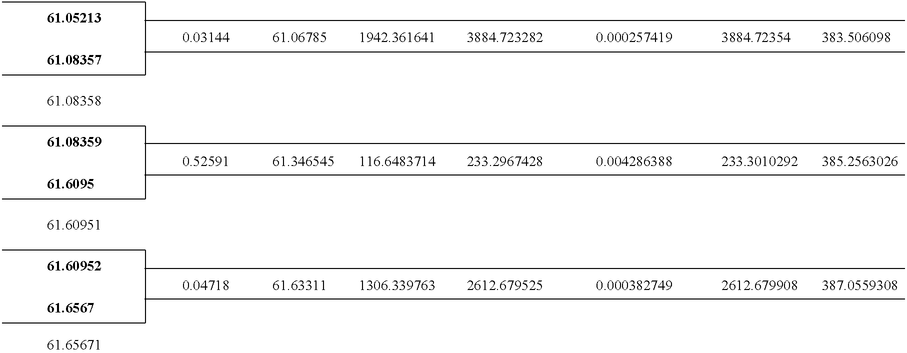

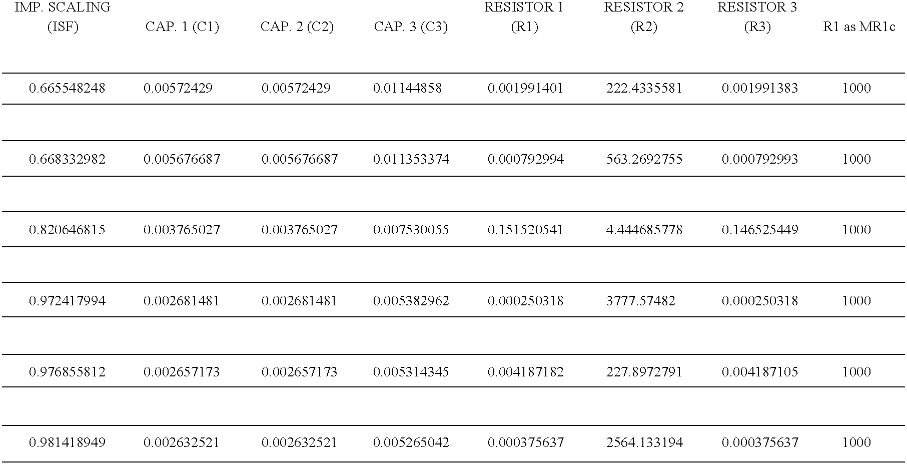

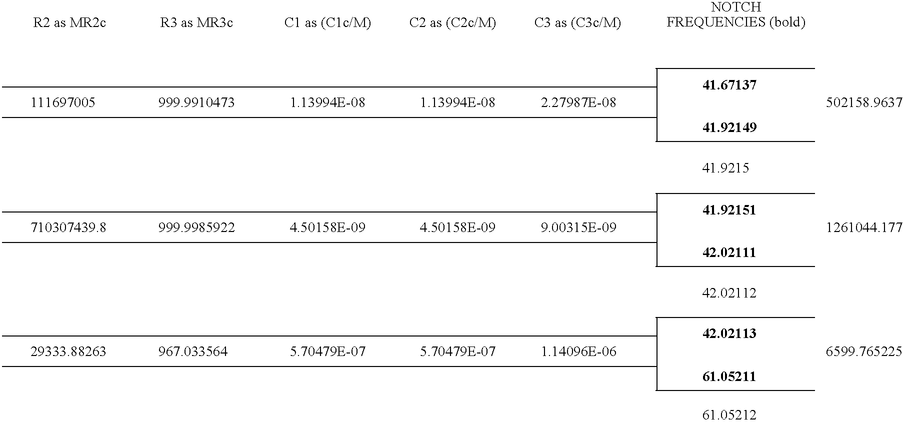

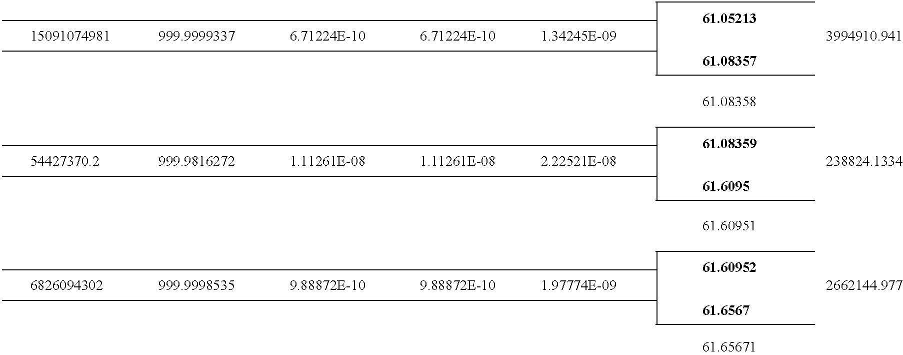

TABLE A 4

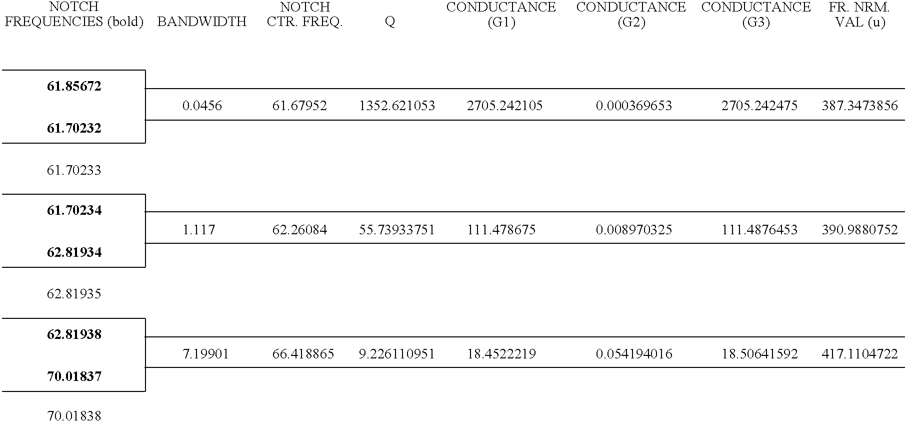

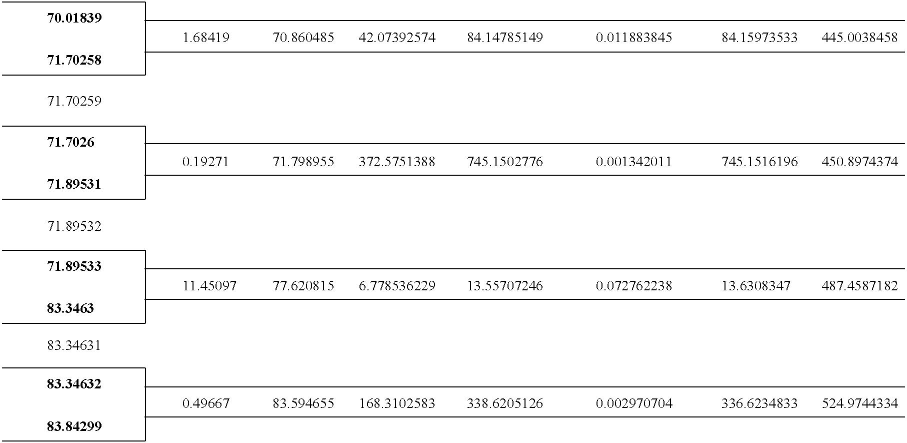

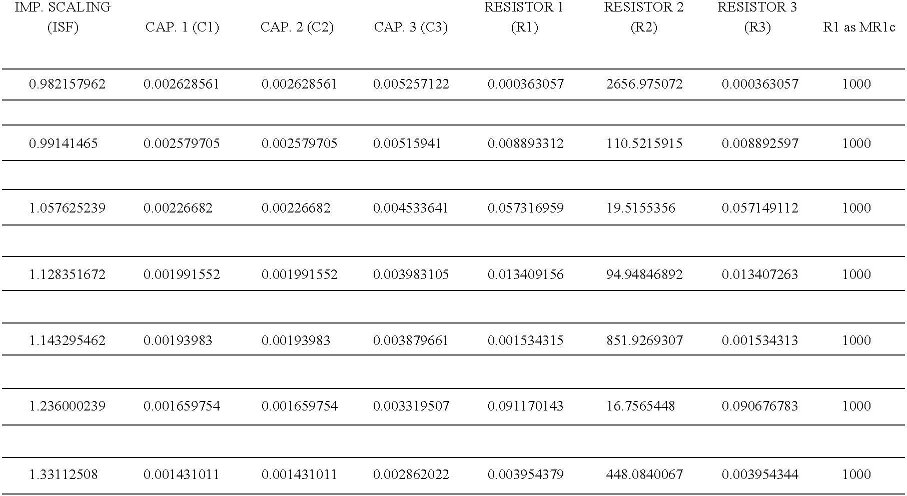

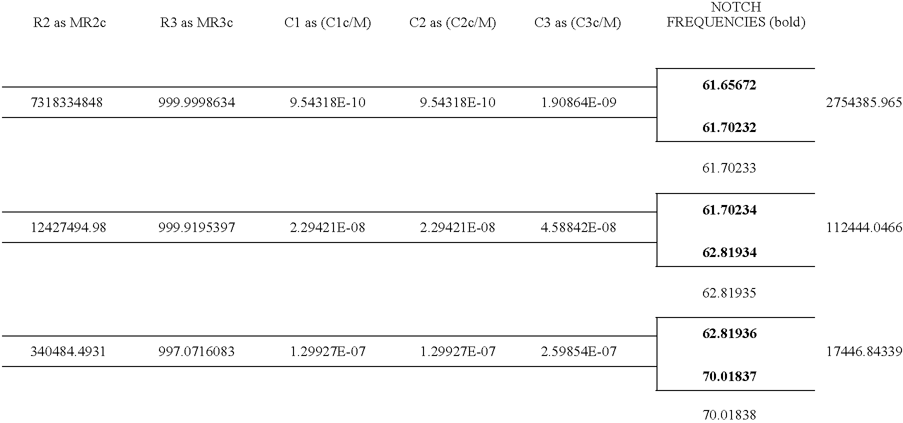

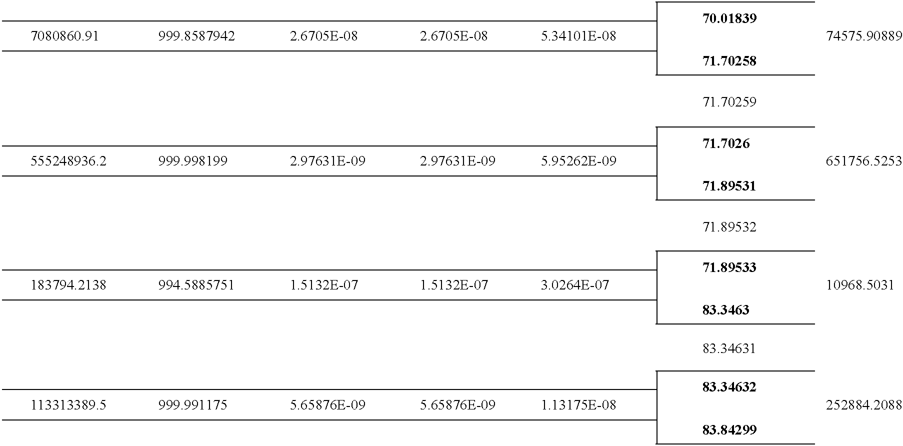

TAB LE A 5

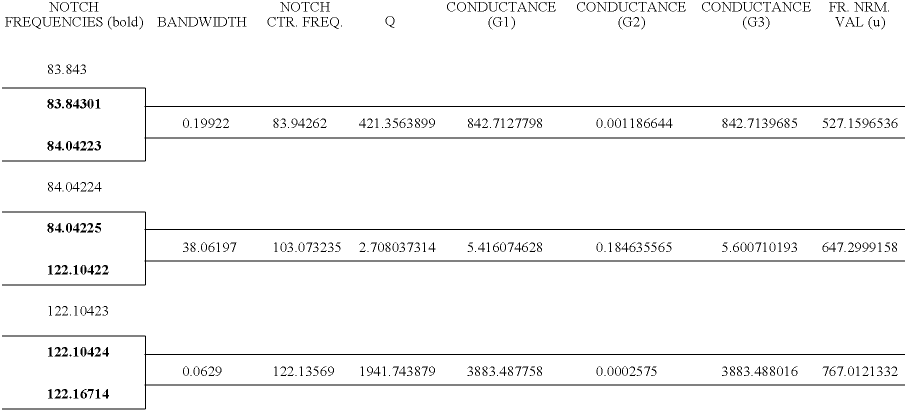

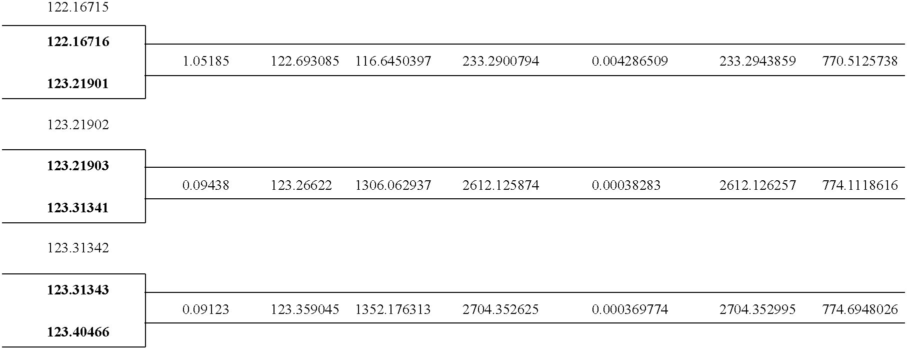

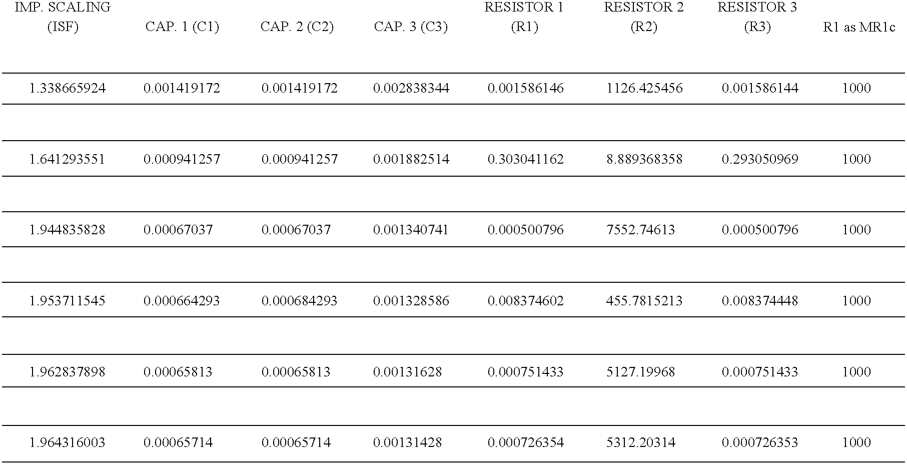

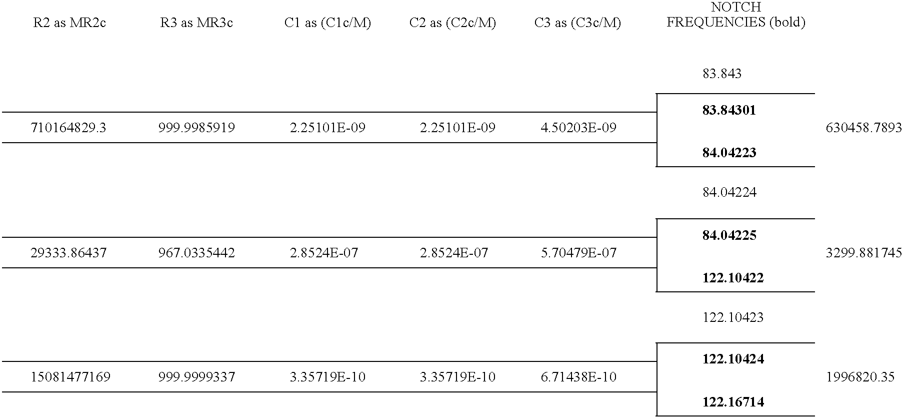

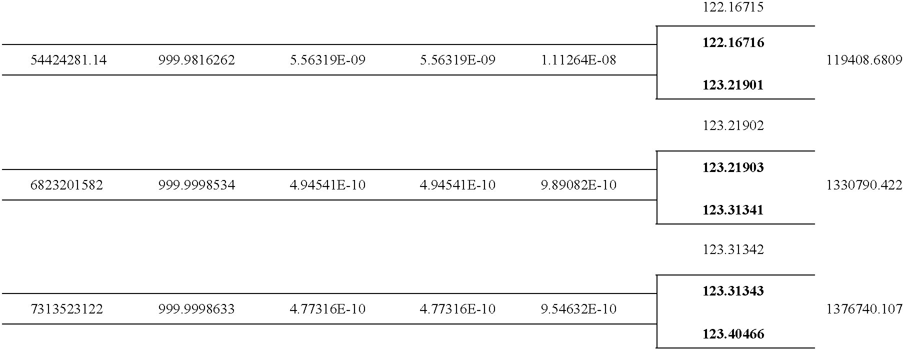

TABLE A 6

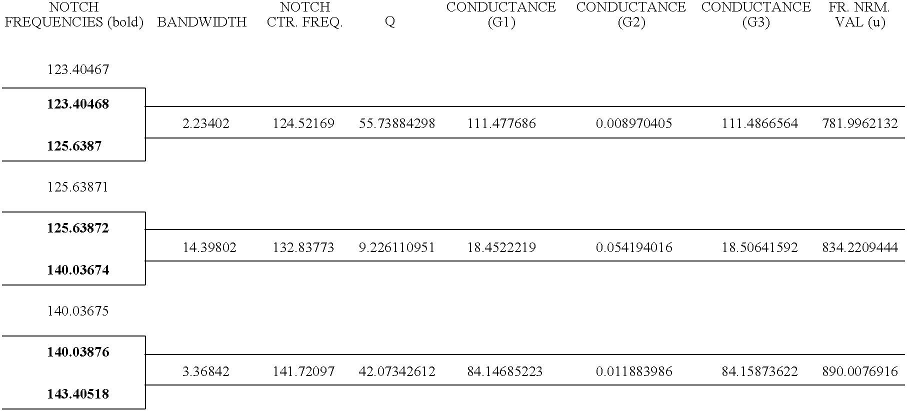

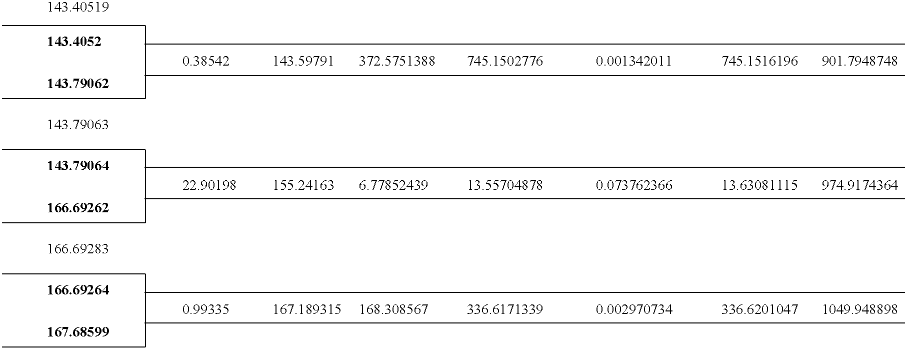

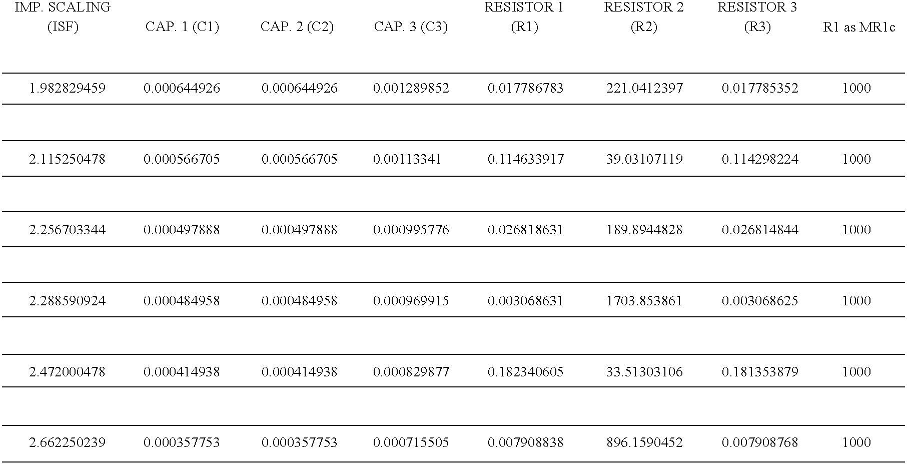

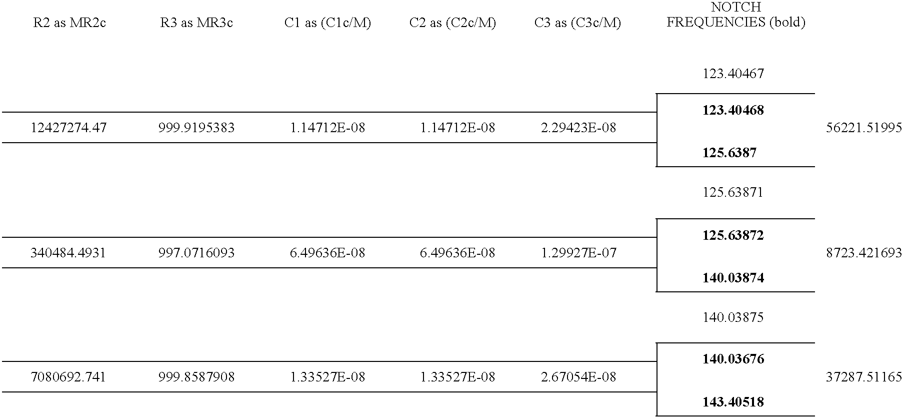

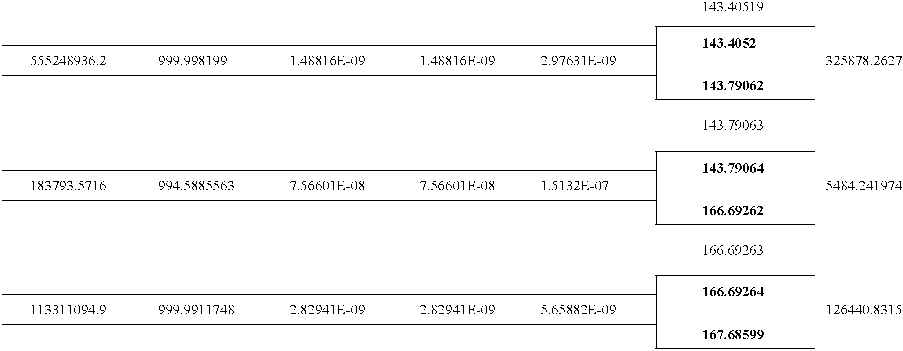

TABLE A 7

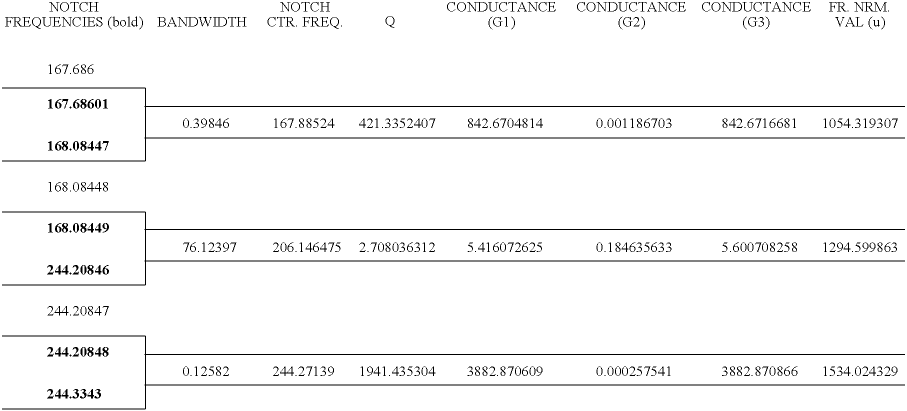

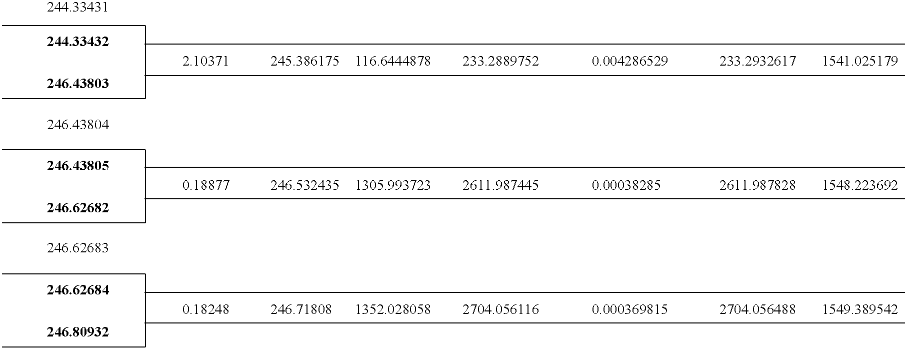

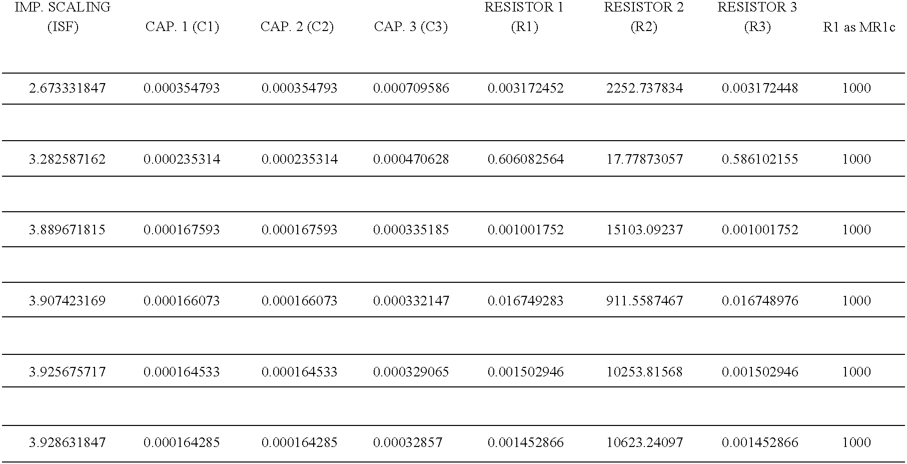

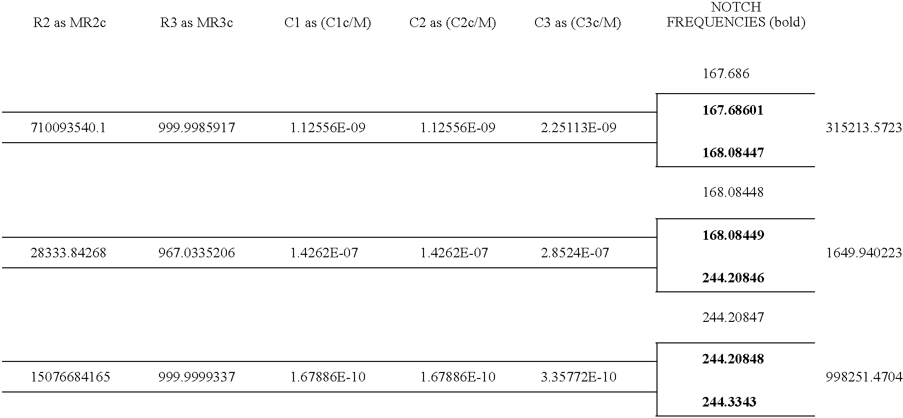

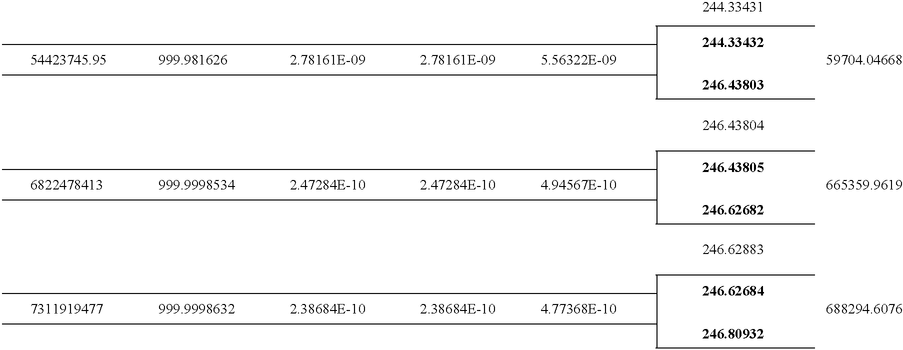

TABLE A 8

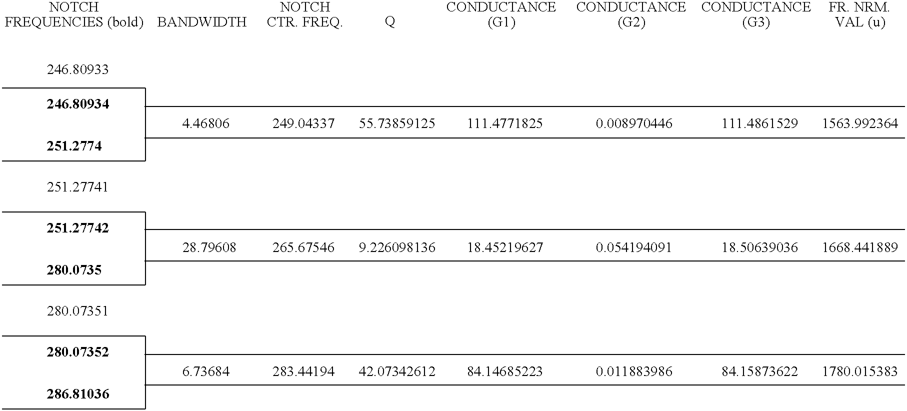

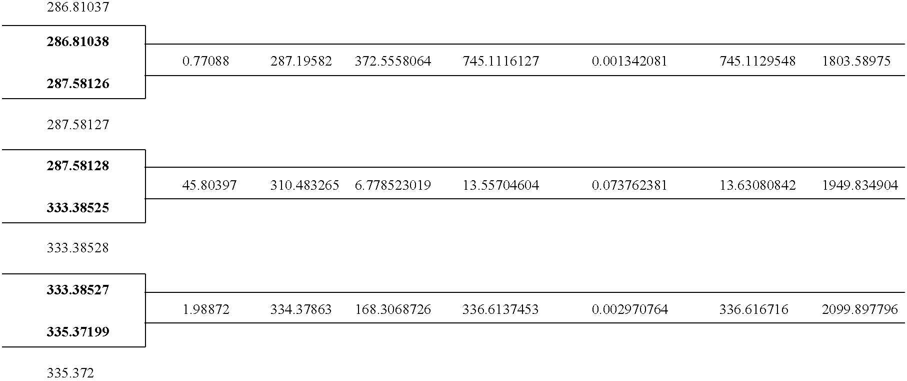

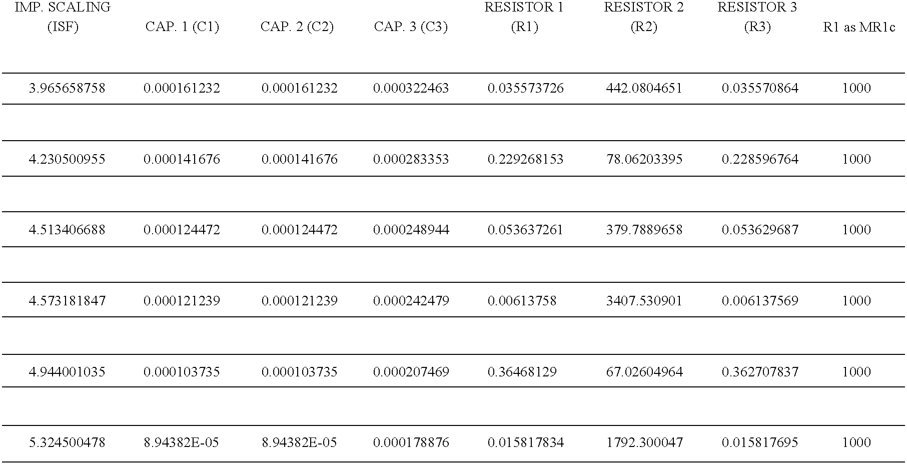

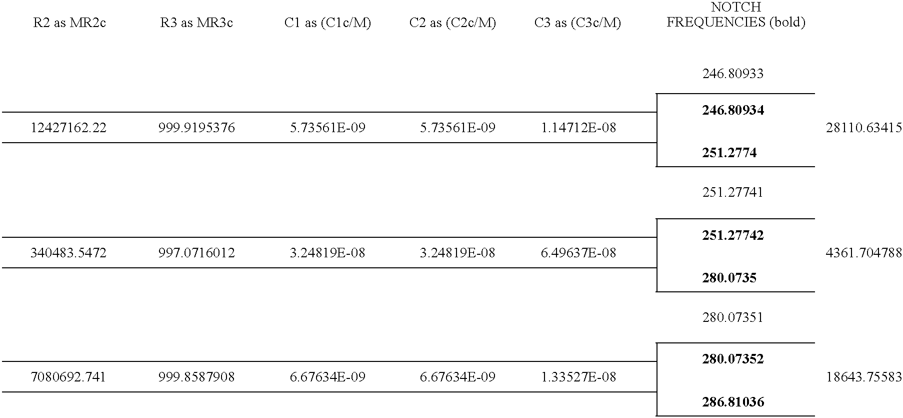

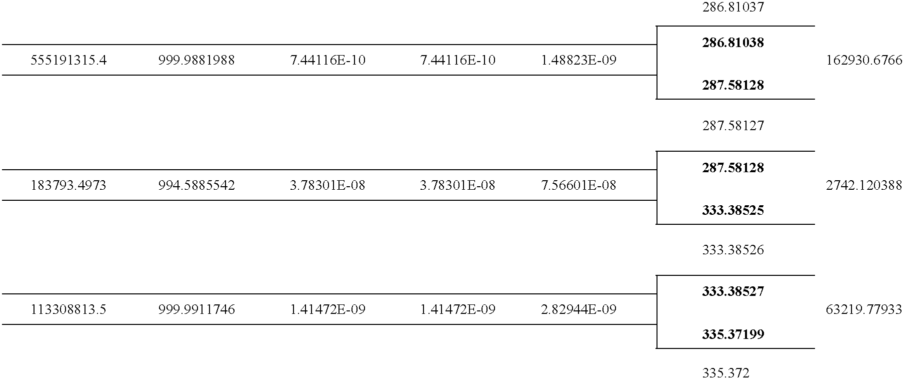

TABLE A 9

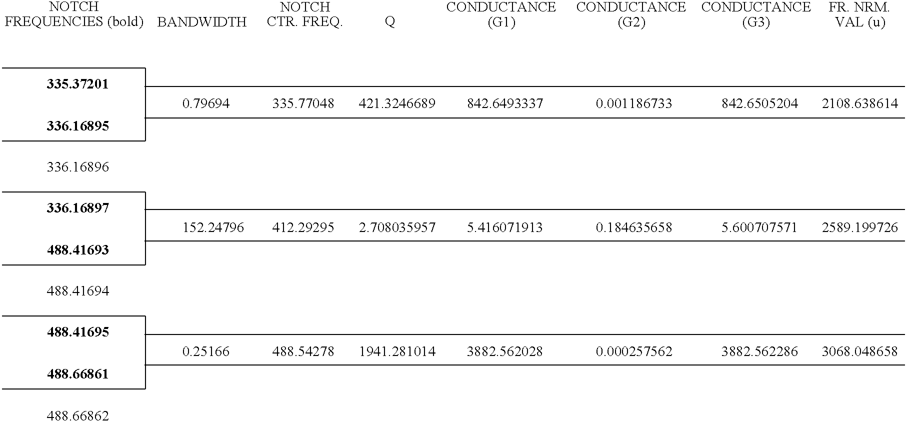

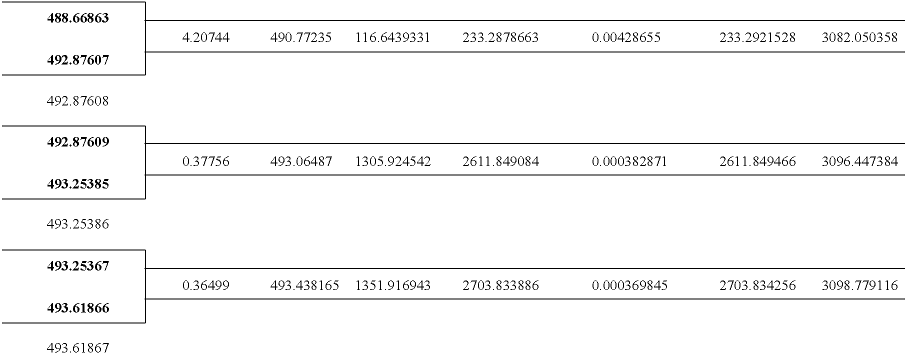

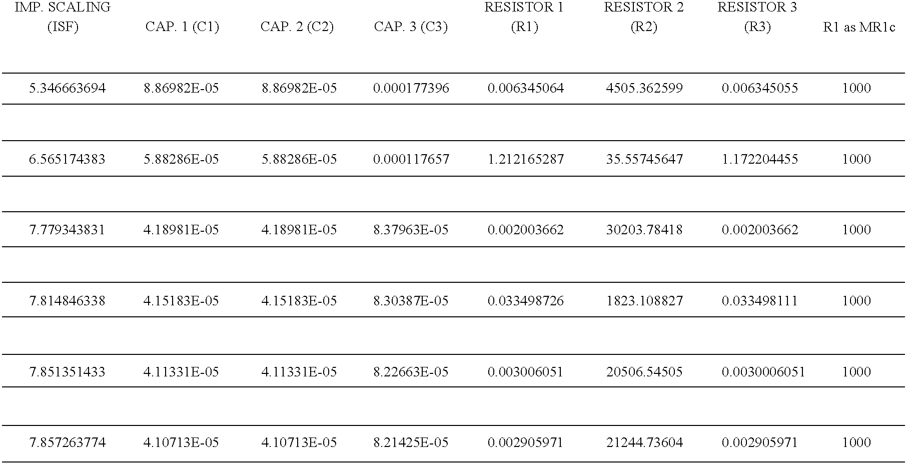

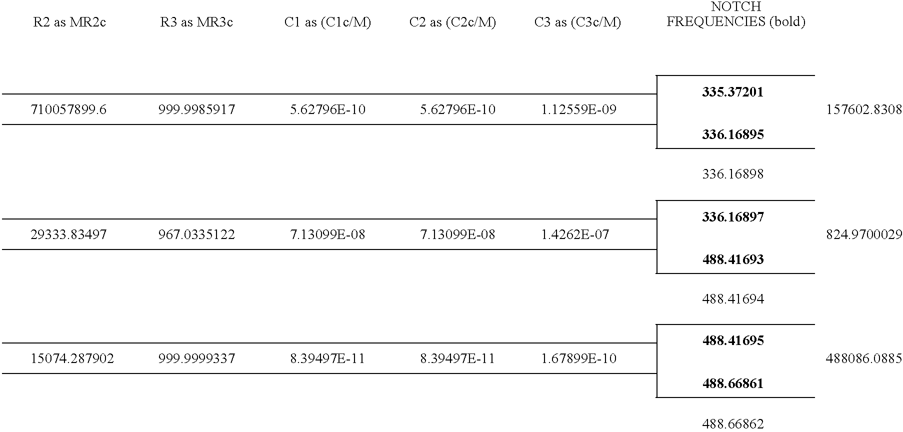

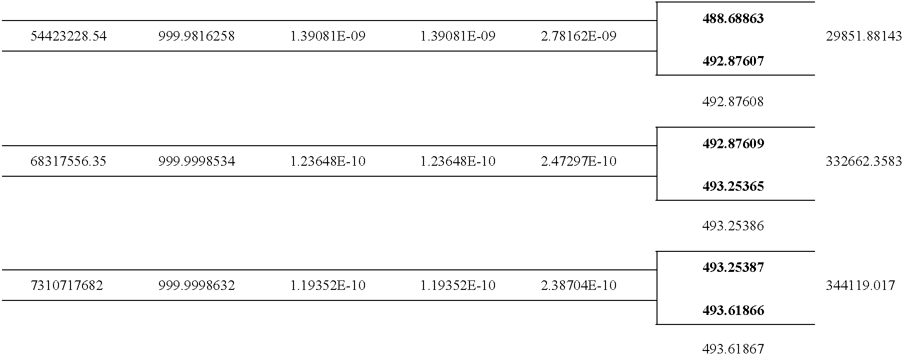

TABLE A 10

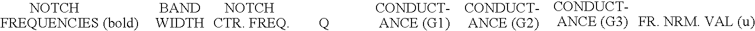

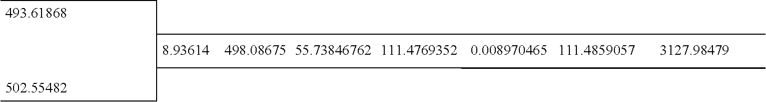

502.55483

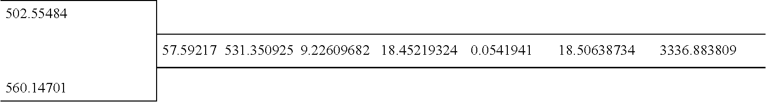

560.14702

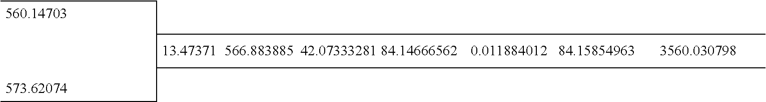

573.62075

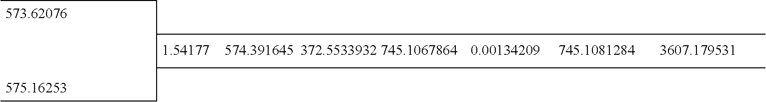

575.16254

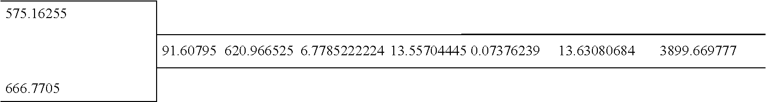

666.77051

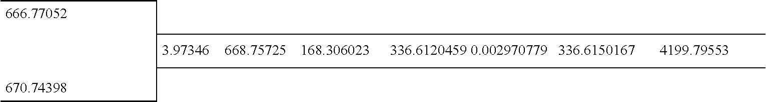

670.74399

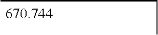

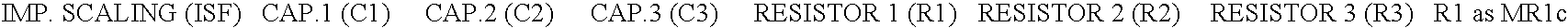

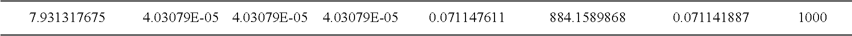

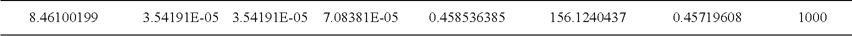

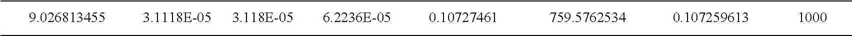

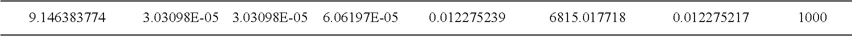

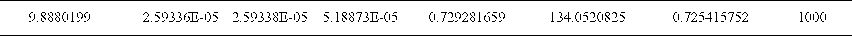

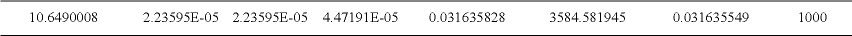

| 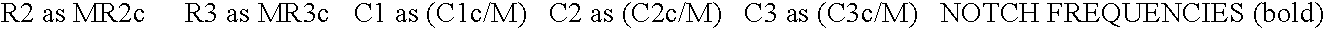 | |
|---|---|
| 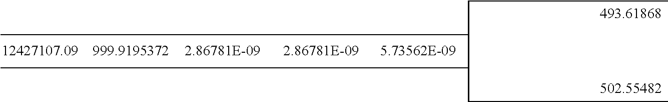 | 14055.28562 |
| 502.55483 | |
| 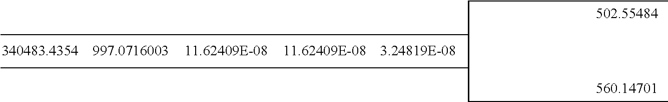 | 2180.852015 |
| 560.14702 | |
| 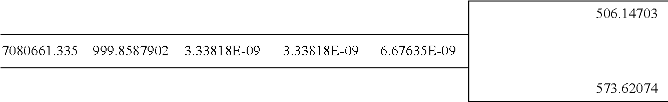 | 9321.857157 |
| 573.62075 | |
| 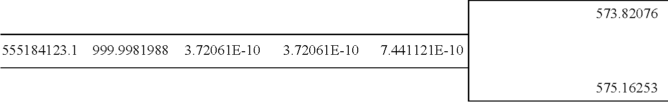 | 81484.80993 |
| 575.16254 | |
| 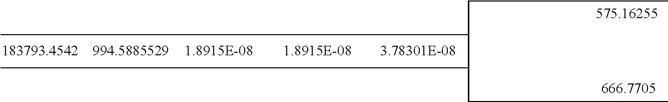 | 1371.060044 |
| 666.77051 | |
| 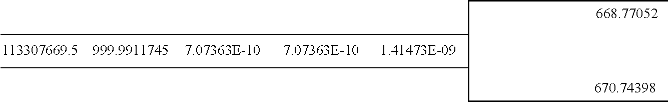 | 31609.73056 |
| 670.74399 | |
| 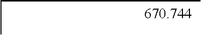 | |

TABLE A 11

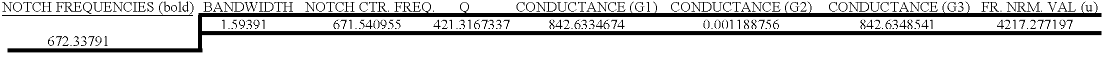

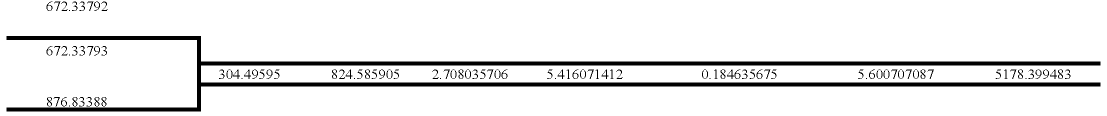

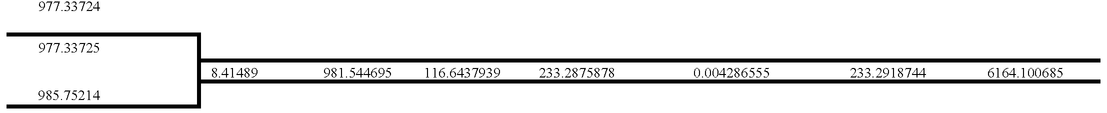

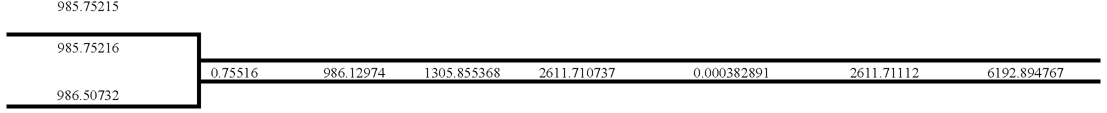

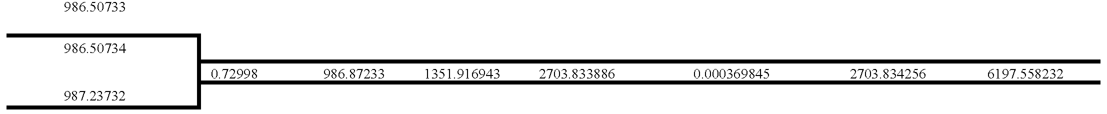

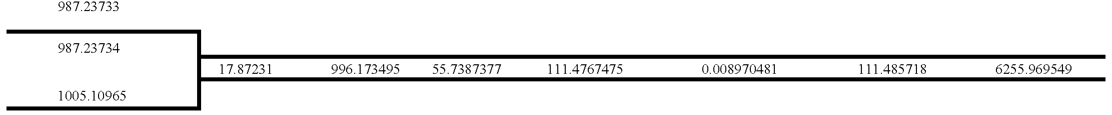

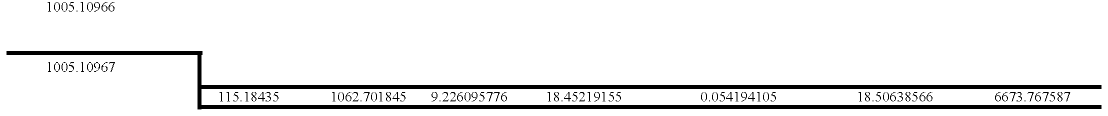

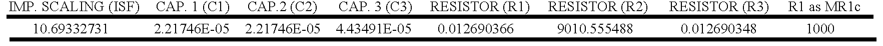

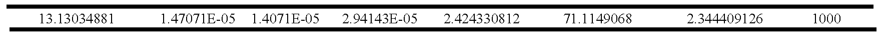

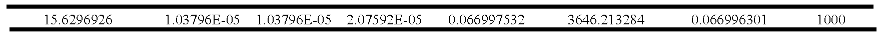

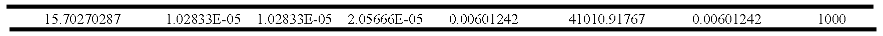

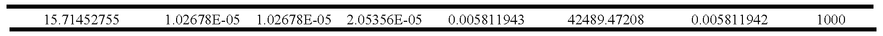

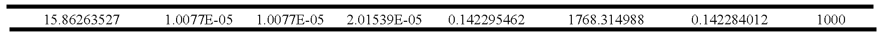

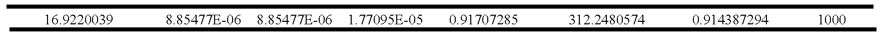

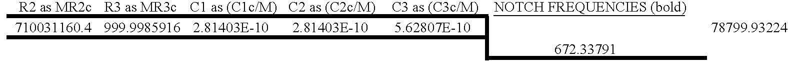

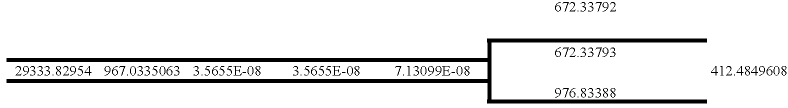

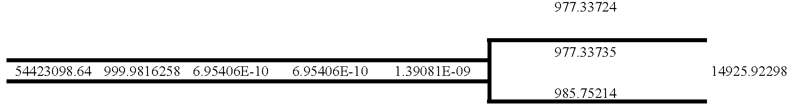

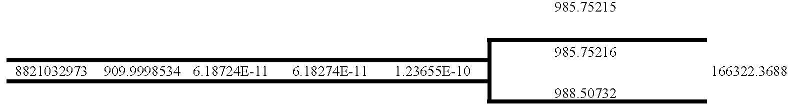

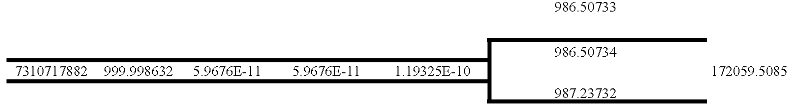

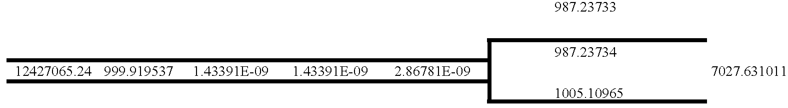

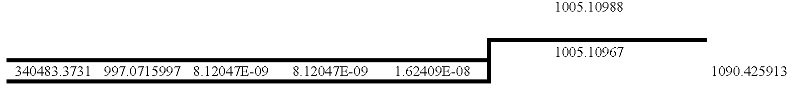

TABLE A 12

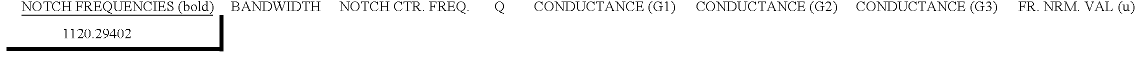

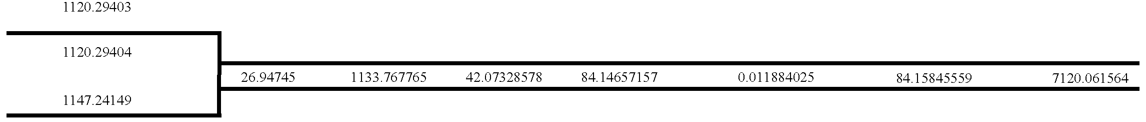

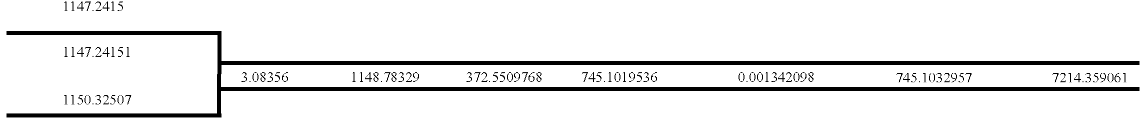

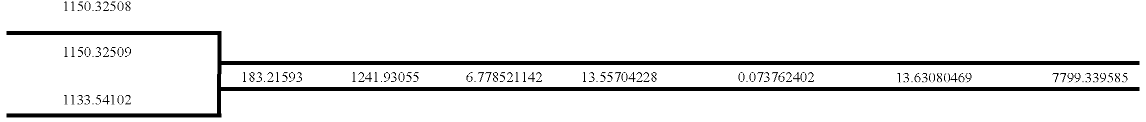

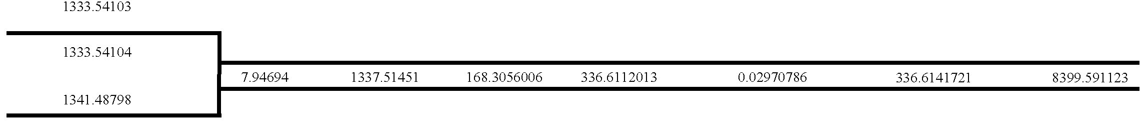

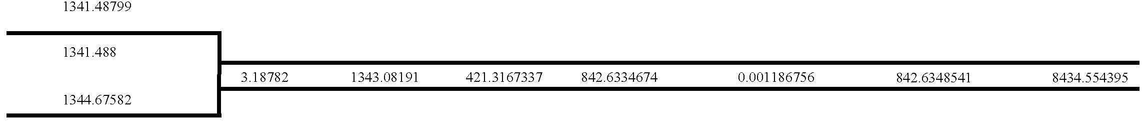

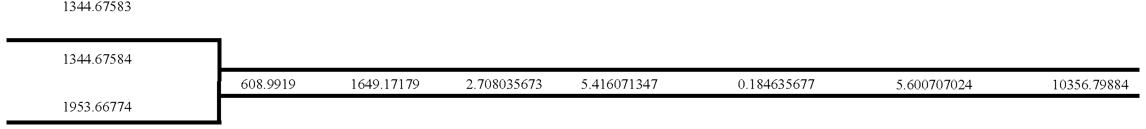

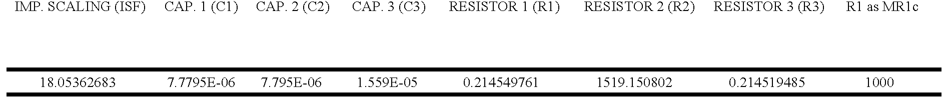

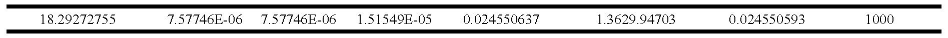

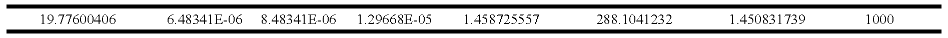

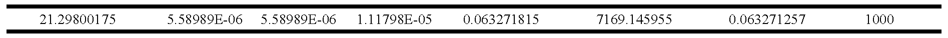

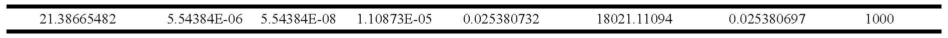

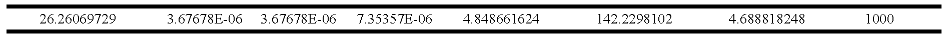

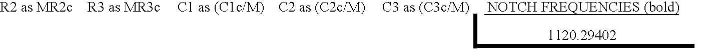

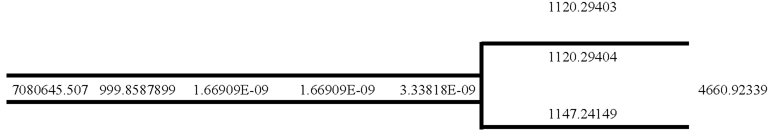

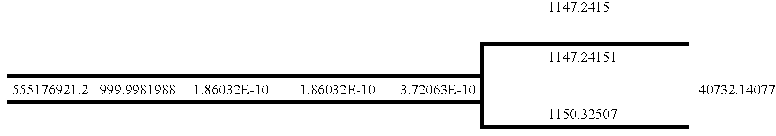

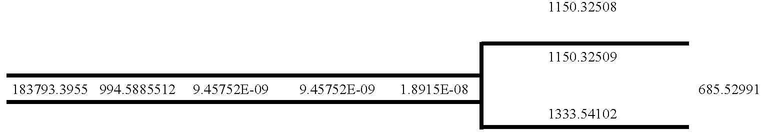

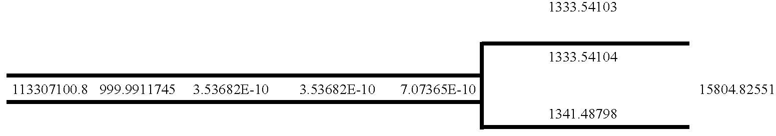

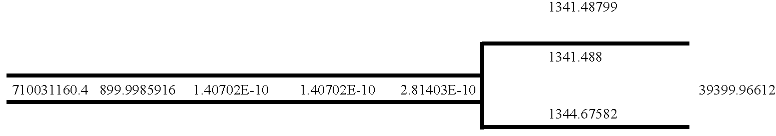

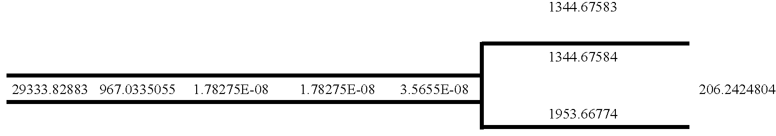

TABLE A 13

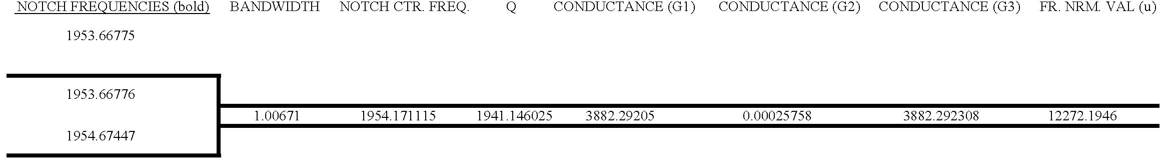

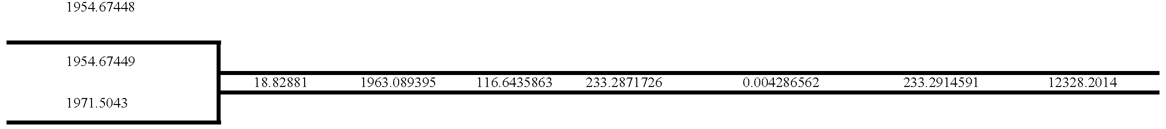

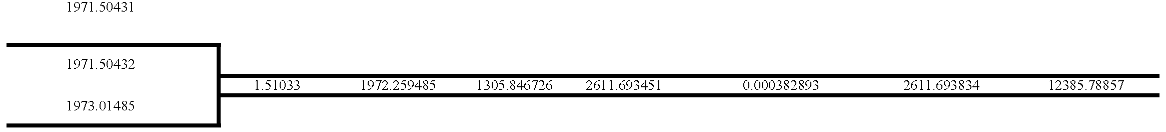

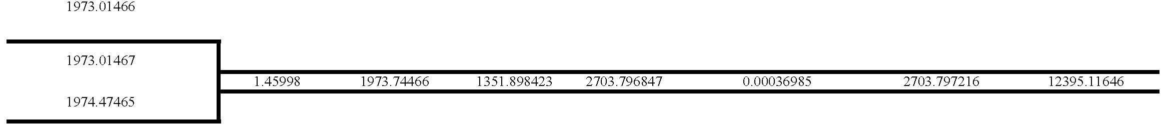

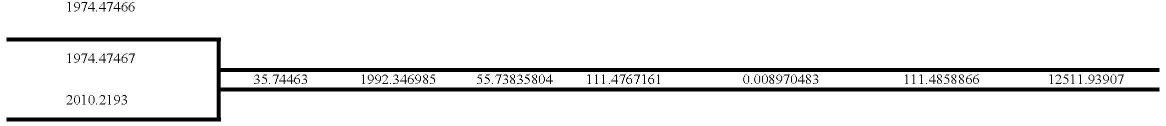

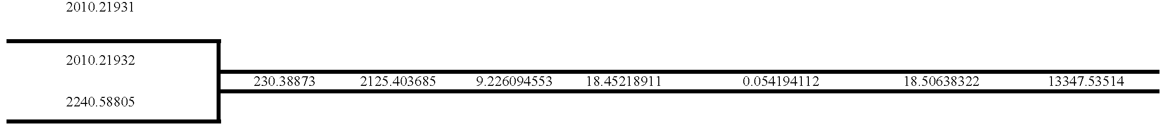

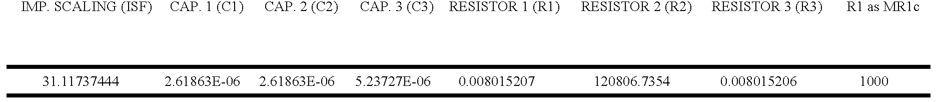

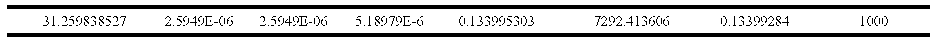

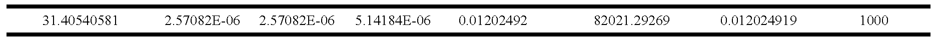

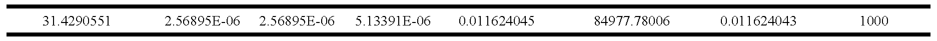

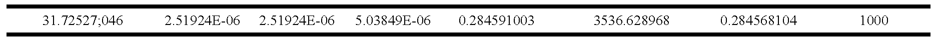

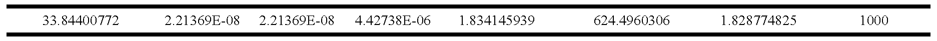

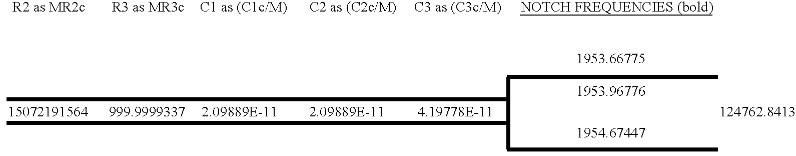

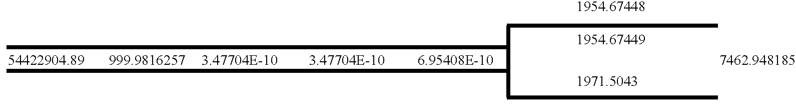

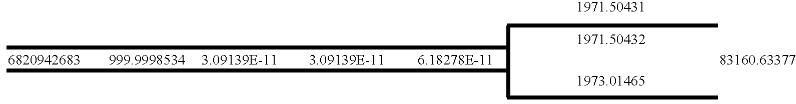

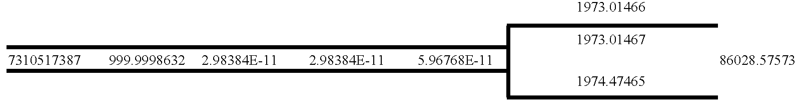

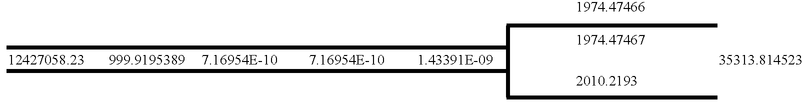

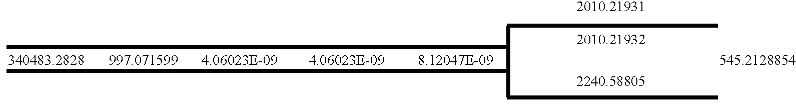

TABLE A 14

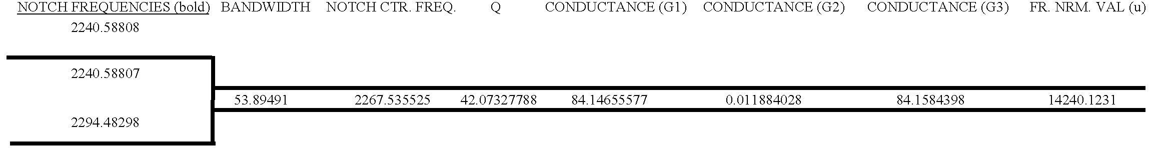

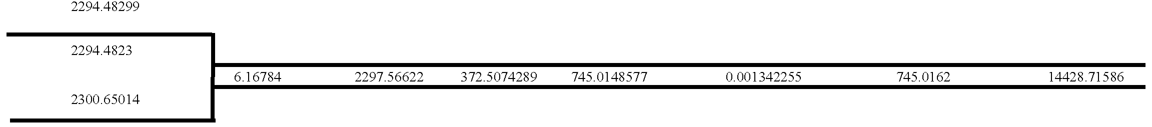

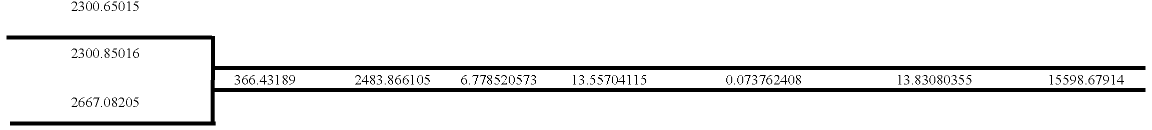

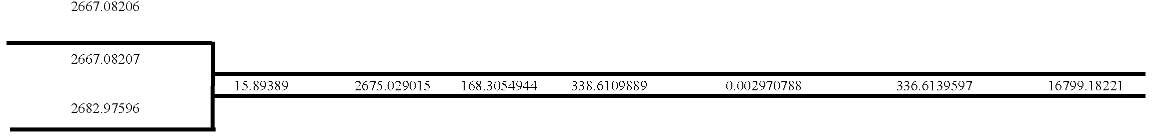

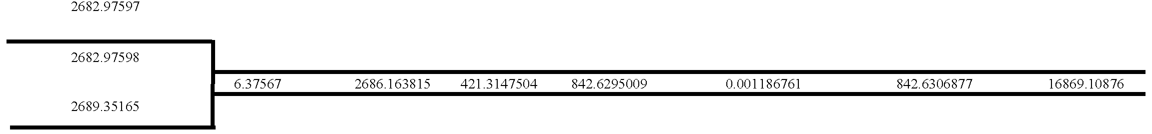

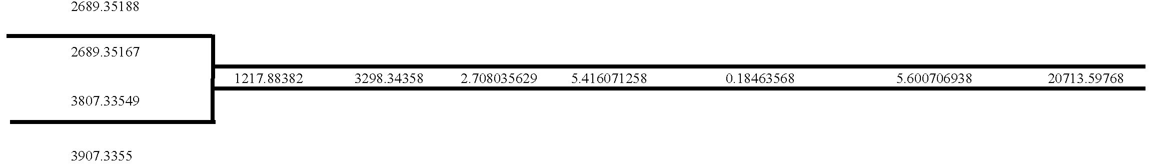

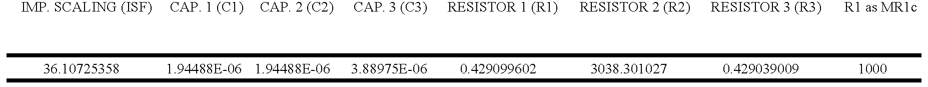

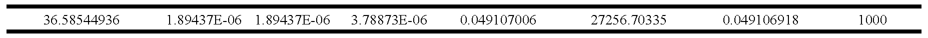

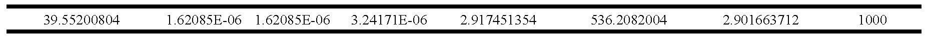

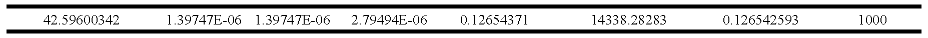

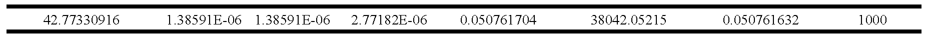

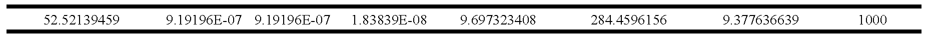

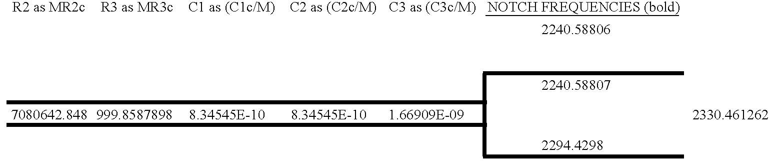

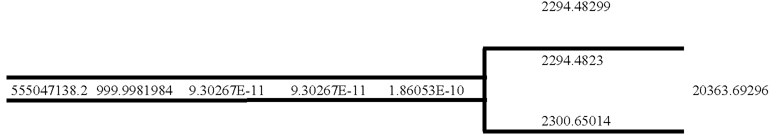

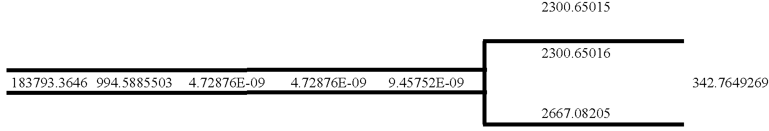

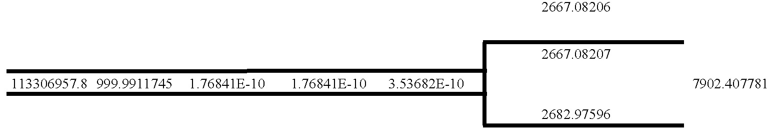

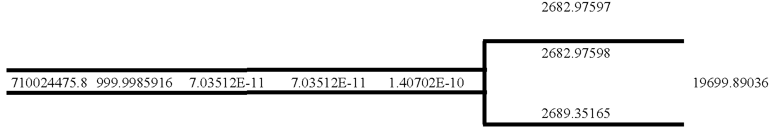

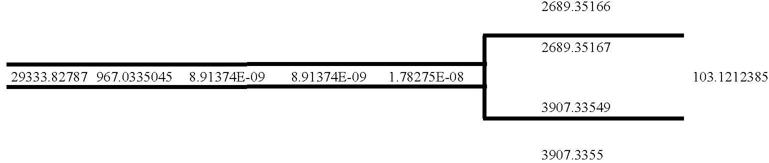

TABLE A 15

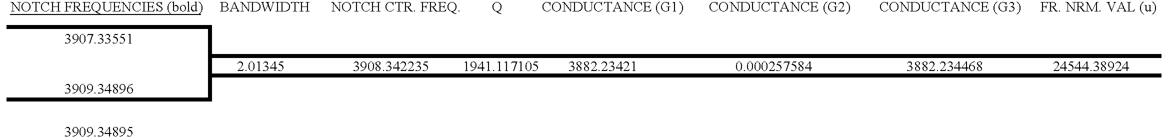

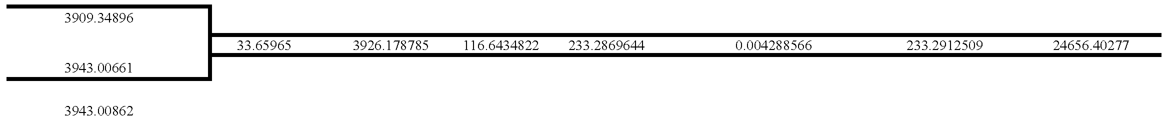

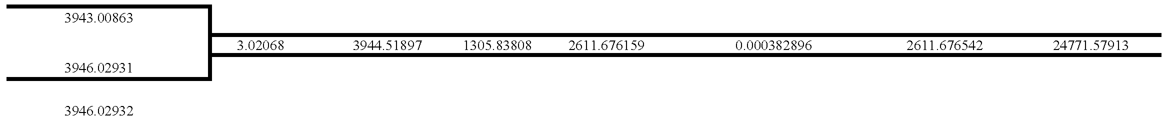

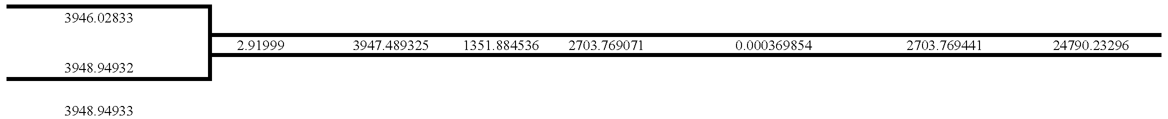

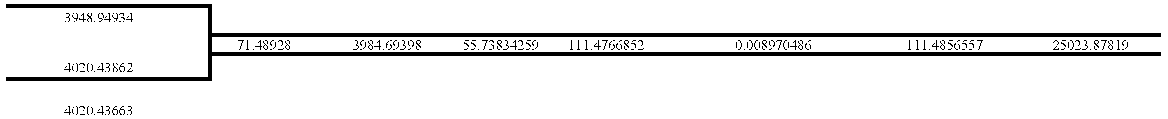

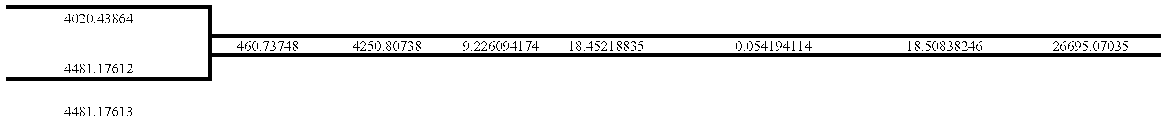

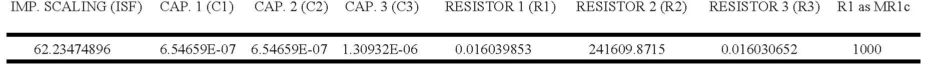

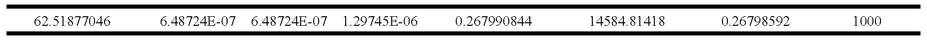

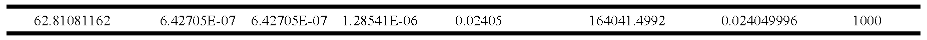

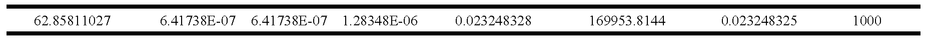

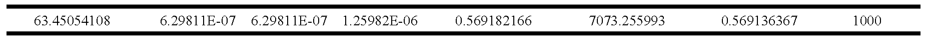

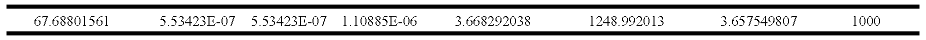

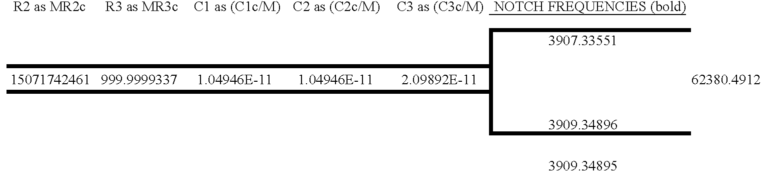

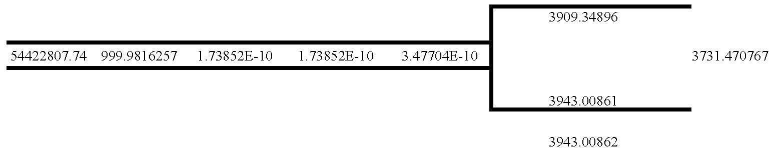

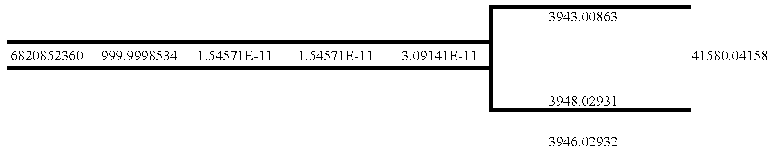

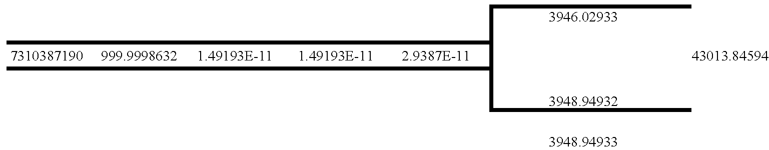

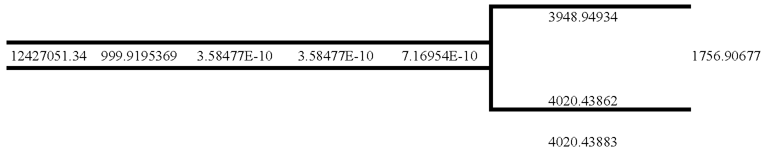

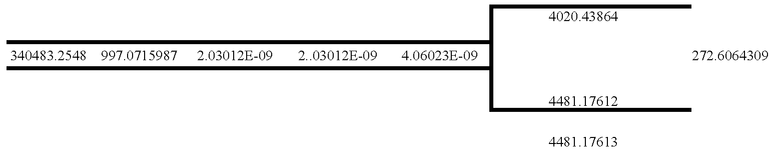

TABLE A 16

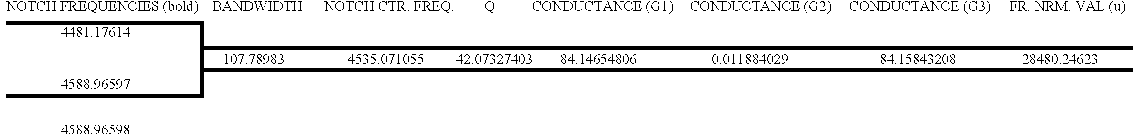

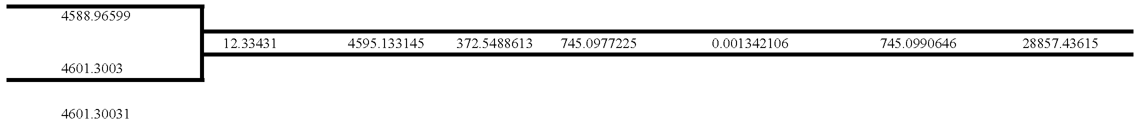

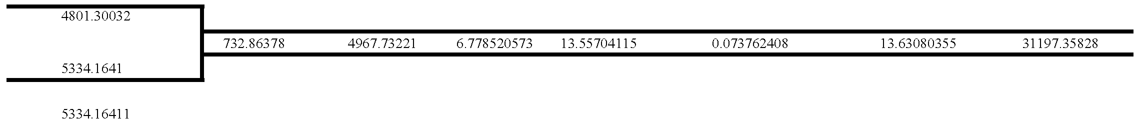

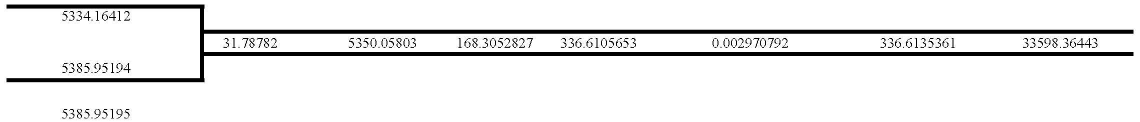

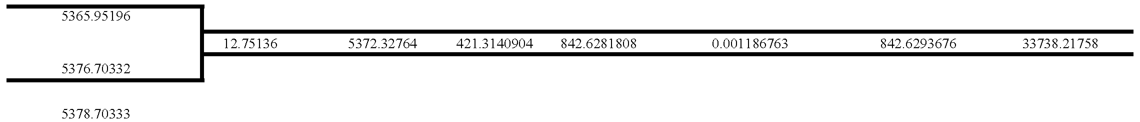

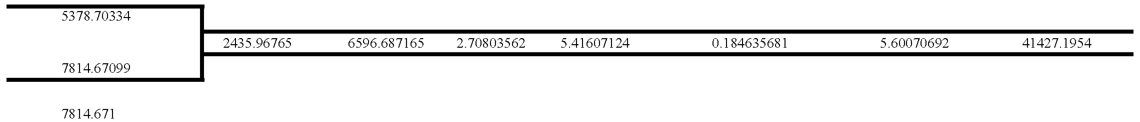

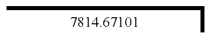

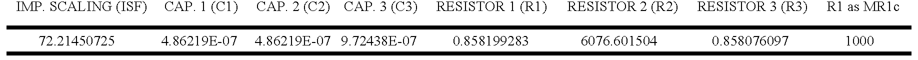

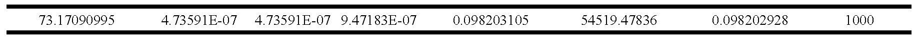

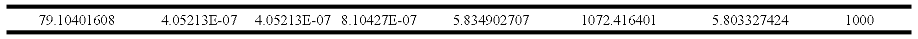

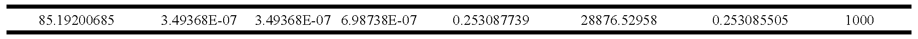

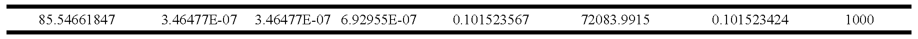

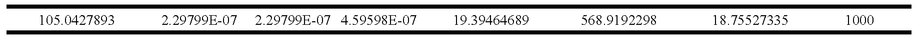

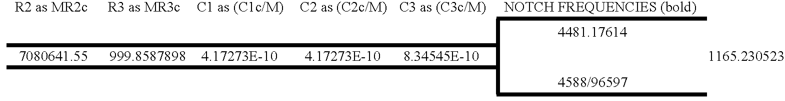

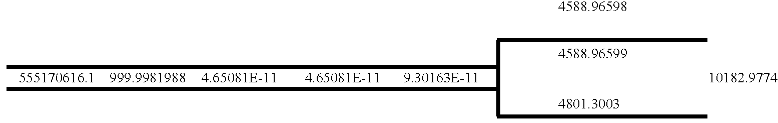

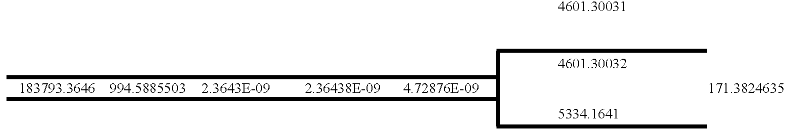

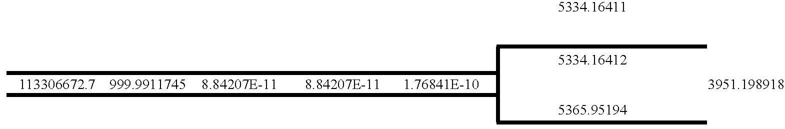

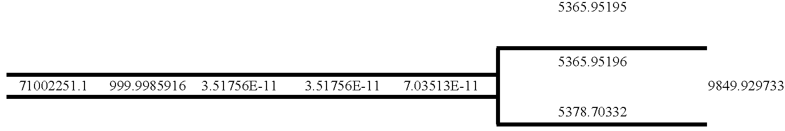

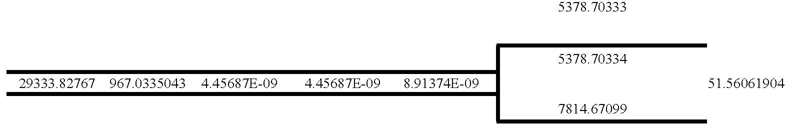

TABLE A 17

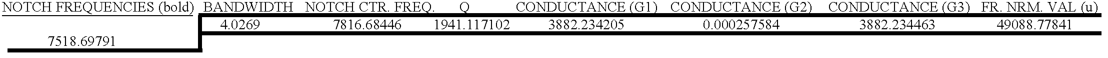

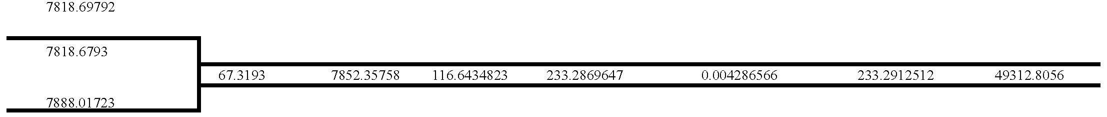

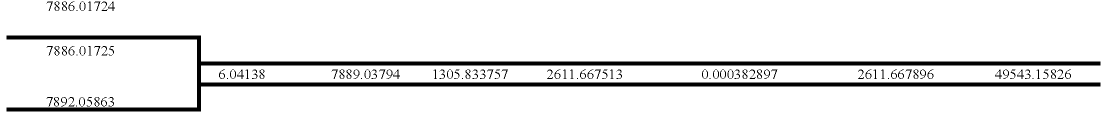

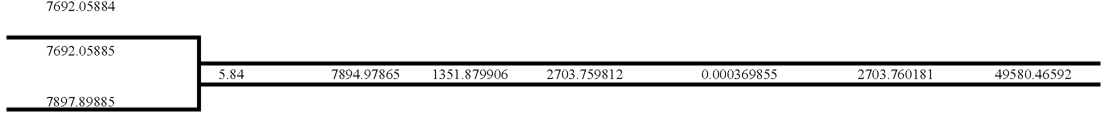

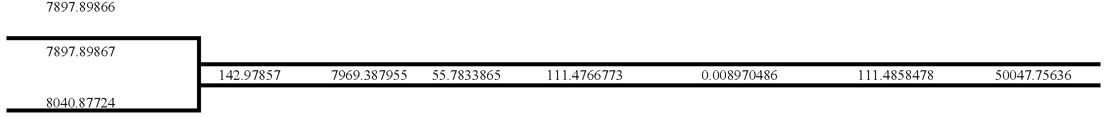

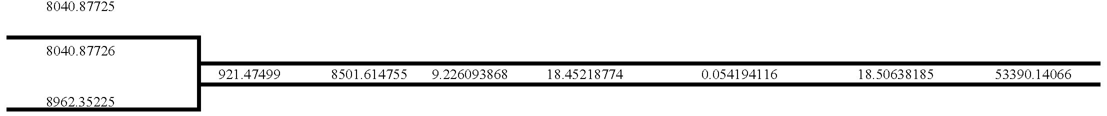

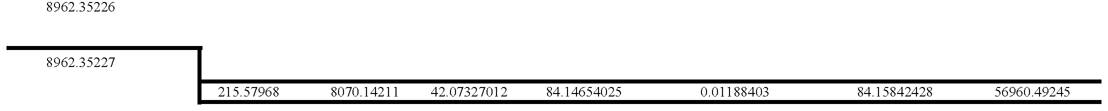

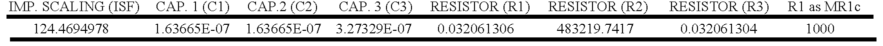

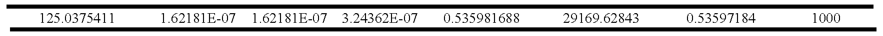

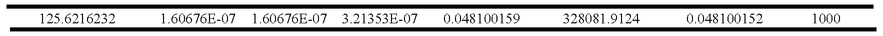

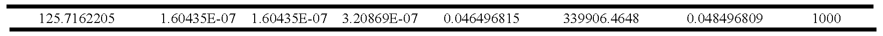

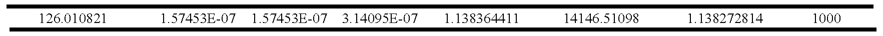

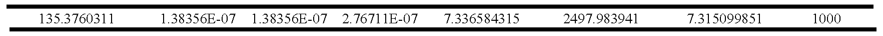

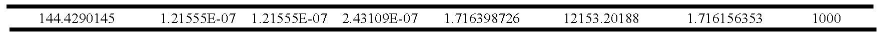

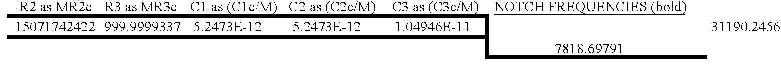

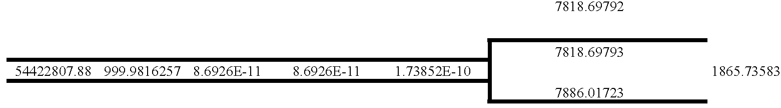

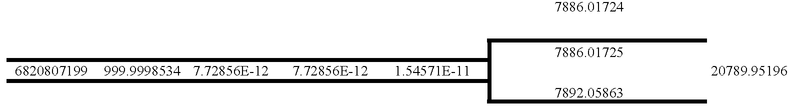

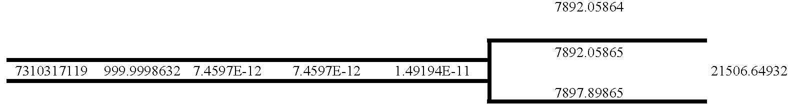

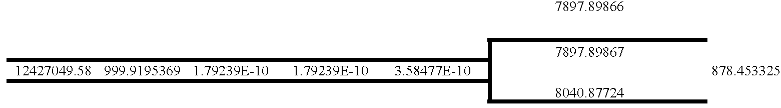

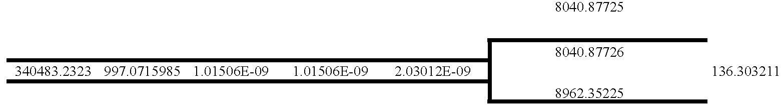

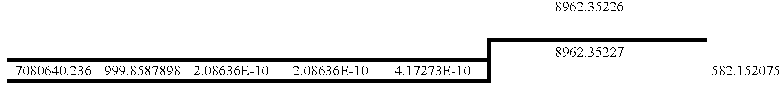

TABLE A 18

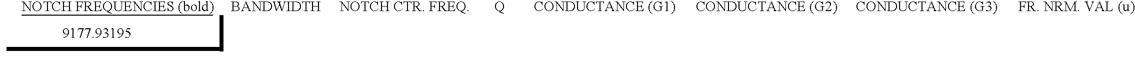

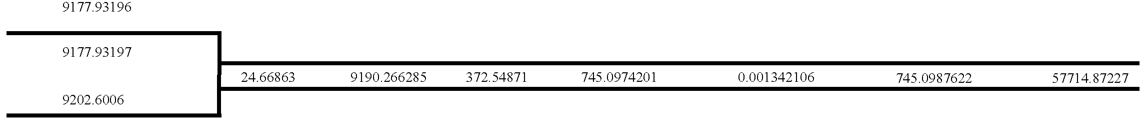

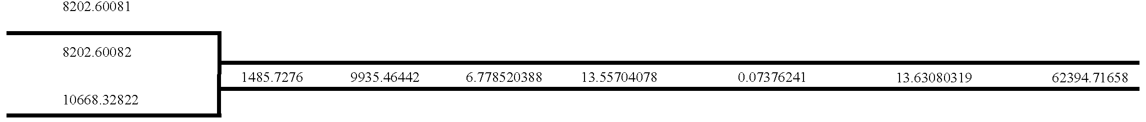

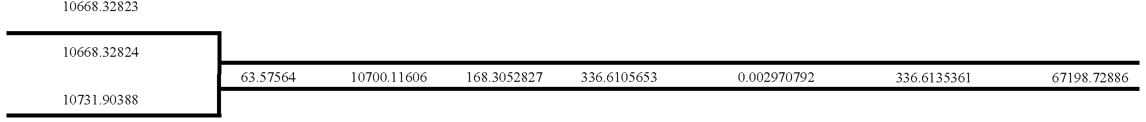

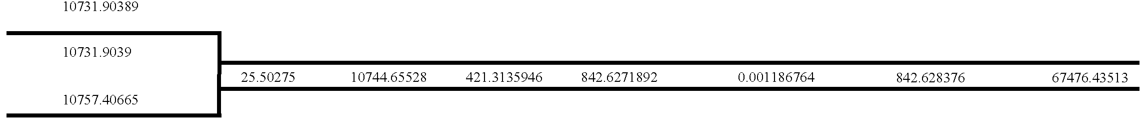

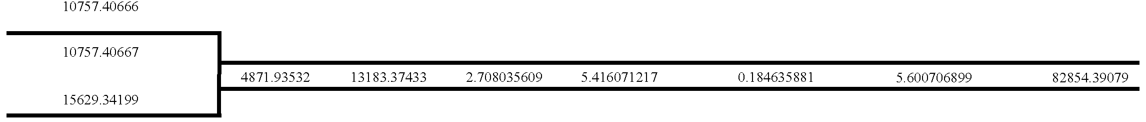

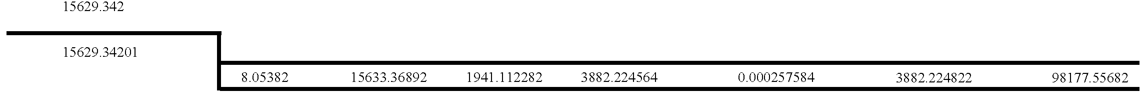

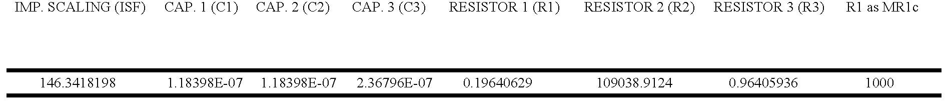

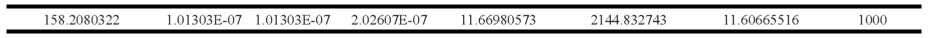

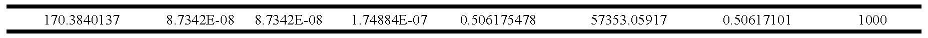

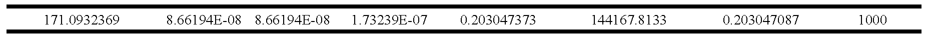

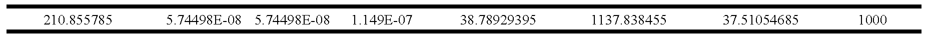

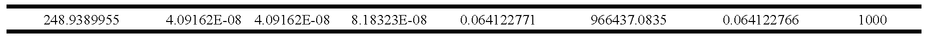

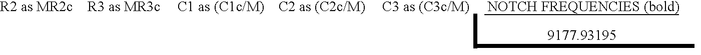

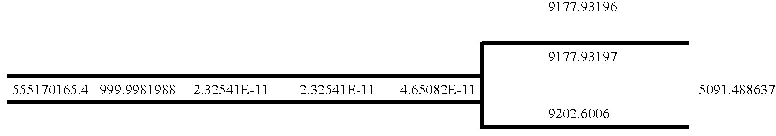

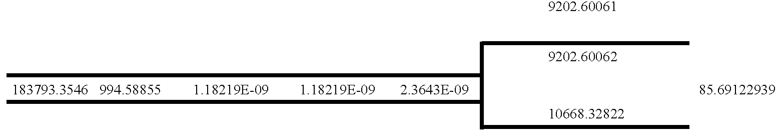

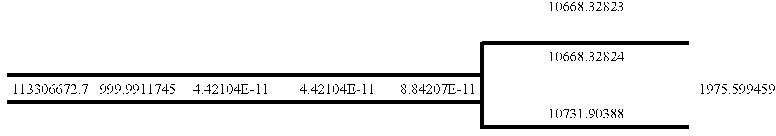

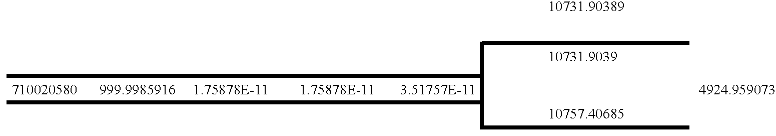

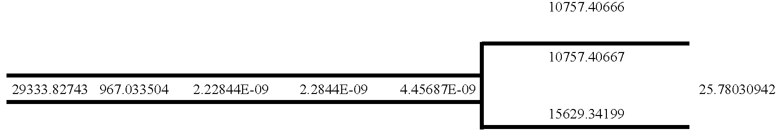

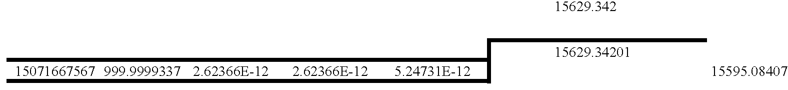

TABLE A 19

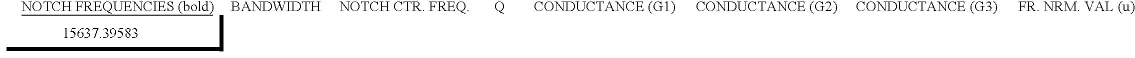

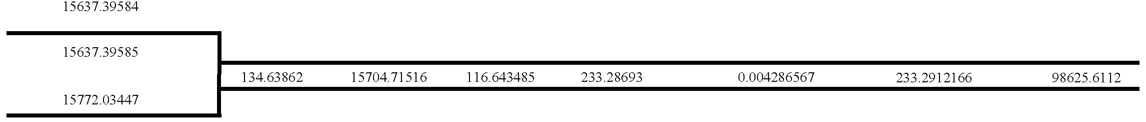

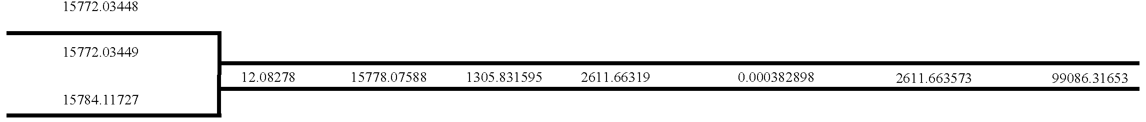

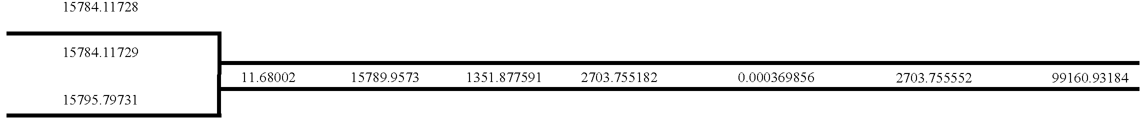

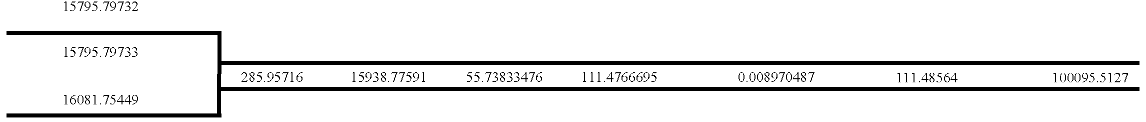

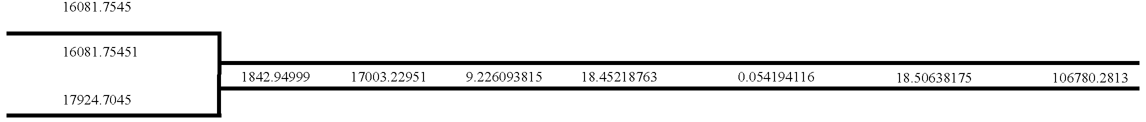

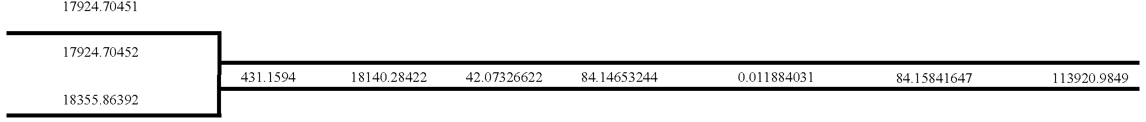

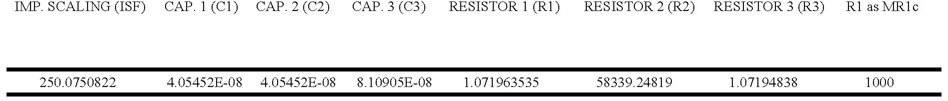

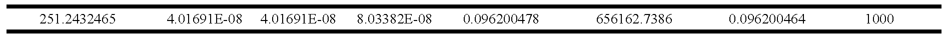

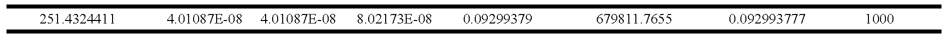

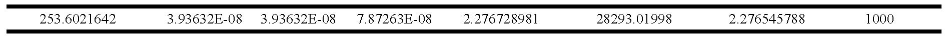

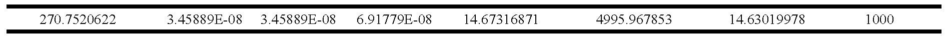

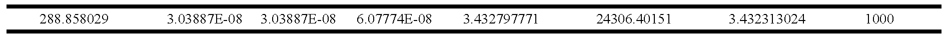

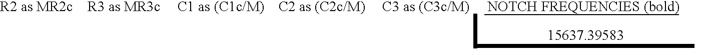

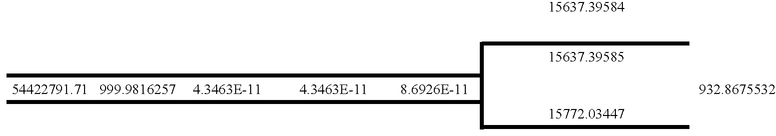

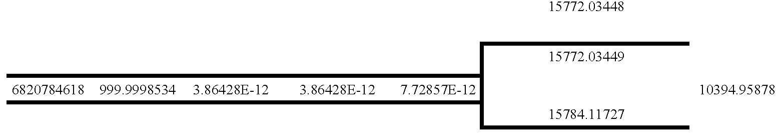

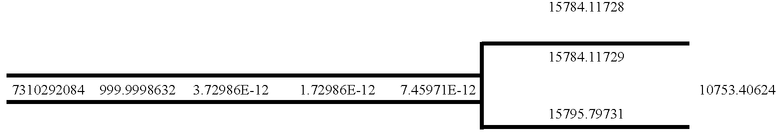

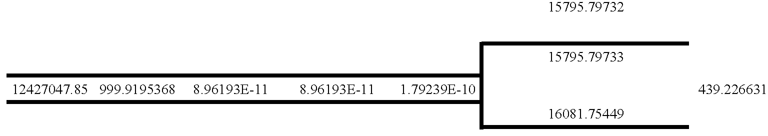

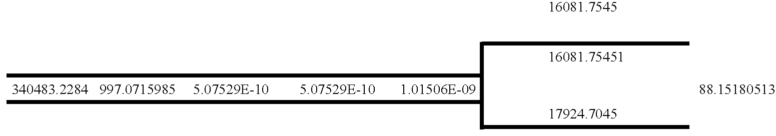

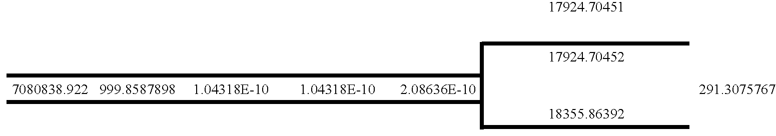

TABLE A 20

| NOTCH | | | | | | | |
|---|---|---|---|---|---|---|---|
| FREQUEN- | | NOTCH | | | | | |
| CIES | BAND- | CTR. | | CONDUCT- | CONDUCT- | CONDUCT- | FR. NRM. |
| (bold) | WIDTH | FREQ. | Q | ANCE (G1) | ANCE (G2) | ANCE (G3) | VAL (u) |
| 18355.88393 | | | | | | | |
| 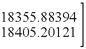 | 49.33727 | 18380.53258 | 372.5488346 | 745.0972693 | 0.001342107 | 745.0986114 | 115429.7448 |
| 18405.20122 | | | | | | | |
| 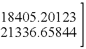 | 2931.45521 | 19870.92884 | 6.778520383 | 13.55704073 | 0.07376241 | 13.63080314 | 124789.4331 |
| 21338.65645 | | | | | | | |
| 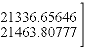 | 127.15131 | 21400.23212 | 168.3052429 | 336.6104858 | 0.002970793 | 338.6134566 | 134393.4577 |
| 21483.80778 | | | | | | | |
| 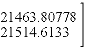 | 51.00551 | 21489.31055 | 421.3135119 | 842.6270238 | 0.001186765 | 842.6282106 | 134952.8702 |
| 21514.81331 | | | | | | | |
| 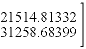 | 9743.87067 | 26386.74866 | 2.7080356 | 5.4160712 | 0.184635682 | 5.600706882 | 165708.7816 |
| 31258.684 | | | | | | | |
| 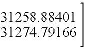 | 16.10765 | 31266.73784 | 1941.111077 | 3882.222153 | 0.000257584 | 3882.222411 | 196355.1136 |
| IMP. | | | | | | | |
| SCALING | CAP. 1 | CAP. 2 | CAP. 3 | RESISTOR | RESISTOR | RESISTOR | R1 as |
| (ISF) | (C1) | (C2) | (C3) | 1 (R1) | 2 (R2) | 3 (R3) | MR1c |
| 292.6838397 | 2.95995E-08 | 2.95995E-08 | 5.91989E-08 | 0.392812659 | 218077.7807 | 0.392811952 | 1000 |
| 316.4160643 | 2.53258E-08 | 2.53258E-08 | 5.06517E-08 | 23.33961154 | 4289.66547 | 23.2133104 | 1000 |
| 340.7680273 | 2.18355E-08 | 2.18355E-08 | 4.3671E-08 | 1.012351194 | 114706.0912 | 1.01234226 | 1000 |
| 342.1864736 | 2.16548E-08 | 2.16548E-08 | 4.33097E-08 | 0.406094825 | 288335.5699 | 0.406094253 | 1000 |
| 420.1711569 | 1.43624E-08 | 1.43824E-08 | 2.87249E-08 | 77.57658814 | 2275.676902 | 75.02109391 | 1000 |
| 497.877991 | 1.0229E-08 | 1.0229E-08 | 2.04581E-08 | 0.128245621 | 1932872.966 | 0.128245613 | 1000 |

| | | | | | NOTCH | |
|---|---|---|---|---|---|---|
| | | | | | FREQUEN- | |
| R2 as | R3 as | C1 as | C2 as | C3 as | CIES | |
| MR2c | MR3c | (C1c/M) | (C2c/M) | (C3cC/M) | (bold) | |
| | | | | | 18355.88393 | |
| 555169940.7 | 999.9981981 | 1.1627E-11 | 1.1627E-11 | 2.32541E-11 | 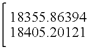 | 2545.742803 |
| | | | | | 18405.20122 | |
| 183793.3533 | 994.58855 | 5.91095E-10 | 5.91095E-10 | 1.18219E-09 | 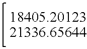 | 42.84561455 |
| | | | | | 21338.65845 | |
| 113306819.2 | 999.9911745 | 2.21052E-11 | 2.21052E-11 | 4.42104E-11 | 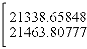 | 987.7994965 |
| | | | | | 21483.80778 | |
| 710020301.3 | 999.9985916 | 8.79392E-12 | 8.79392E-12 | 1.75878E-11 | 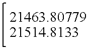 | 2462.479054 |
| | | | | | 21514.81331 | |
| 29333.82724 | 967.0335038 | 1.11422E-09 | 1.11422E-09 | 2.22844E-09 | 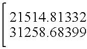 | 12.89015407 |
| | | | | | 31258.684 | |
| 15071848849 | 999.9999337 | 1.31183E-12 | 1.31183E-12 | 2.62356E-12 | 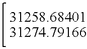 | 7797.537195 |

TABLE A 21

| NOTCH | | | | | | | |
|---|---|---|---|---|---|---|---|
| FREQUEN- | | NOTCH | | | | | |
| CIES | BAND- | CTR. | | CONDUCT- | CONDUCT- | CONDUCT- | FR. NRM. |
| (bold) | WIDTH | FREQ. | Q | ANCE (G1) | ANCE (G2) | ANCE (G3) | VAL (u) |
| 31274.79167 | | | | | | | |
| 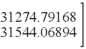 | 269.27726 | 31409.43031 | 116.6434563 | 233.2869126 | 0.004286567 | 233.2911992 | 197251.2223 |
| 31544.06895 | | | | | | | |
| 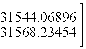 | 24.16558 | 31556.15175 | 1305.830514 | 2611.661028 | 0.000382898 | 2611.661411 | 198172.633 |
| 31568.23455 | | | | | | | |
| 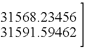 | 23.36008 | 31579.91459 | 1351.876433 | 2703.752866 | 0.000369856 | 2703.753236 | 198321.6636 |
| 31591.59463 | | | | | | | |
| 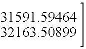 | 571.91435 | 31877.55182 | 55.73833182 | 111.4768636 | 0.008970487 | 111.4856341 | 200191.0254 |
| 32163.509 | | | | | | | |
| 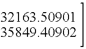 | 3685.90001 | 34006.45902 | 9.226003742 | 18.45218748 | 0.054194117 | 18.5063816 | 213560.5626 |
| 35849 40903 | | | | | | | |
| 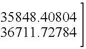 | 862.3188 | 36280.56844 | 42.07326022 | 84.14653244 | 0.011884031 | 84.15841647 | 227841.9698 |
| 38711.72785 | | | | | | | |
| IMP. | | | | | | | |
| SCALING | CAP. 1 | CAP. 2 | CAP. 3 | RESISTOR | RESISTOR | RESISTOR | R1 as |
| (ISF) | (C1) | (C2) | (C3) | 1 (R1) | 2 (R2) | 3 (R3) | MR1c |
| 500.1501642 | 1.01383E-08 | 1.01383E-08 | 2.02726E-08 | 2.143927229 | 116678.4876 | 2.143887636 | 1000 |
| 502.4864928 | 1.00423E-08 | 1.00423E-08 | 2.00845E-08 | 0.192401115 | 1312324.39 | 0.192401086 | 1000 |
| 502.864882 | 1.00272E-08 | 1.00272E-08 | 2.00543E-08 | 0.185987739 | 1359622.366 | 0.185987713 | 1000 |
| 507.6043283 | 9.84079E-09 | 9.84079E-09 | 1.96816E-08 | 4.553458201 | 56586.03897 | 4.553091815 | 1000 |
| 541.5041244 | 8.64723E-09 | 8.64723E-09 | 1.72945E-08 | 29.34833766 | 9991.935627 | 29.2603998 | 1000 |
| 577.716058 | 7.59717E-09 | 7.59717E-09 | 1.51943E-08 | 6.865595541 | 48612.80301 | 6.864626049 | 1000 |

| | | | | | NOTCH | |
|---|---|---|---|---|---|---|
| | | | | | FREQUEN- | |
| R2 as | R3 as | C1 as | C2 as | C3 as | CIES | |
| MR2c | MR3c | (C1c/M) | (C2c/M) | (C3cC/M) | (bold) | |
| | | | | | 31274.79167 | |
| 54422783.59 | 999.9816257 | 2.17315E-11 | 2.17315E-11 | 4.3463E-11 | 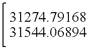 | 408.4337419 |
| | | | | | 31544.06895 | |
| 6820773324 | 999.9998534 | 1.93214E-12 | 1.93214E-12 | 3.86429E-12 | 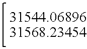 | 5197.475086 |
| | | | | | 31568.23455 | |
| 7310279562 | 999.9998632 | 1.86493E-12 | 1.86493E-12 | 3.72986E-12 | 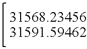 | 5376.698519 |
| | | | | | 31591.59483 | |
| 12427048.54 | 999.9195388 | 4.48096E-11 | 4.48096E-11 | 8.96193E-11 | 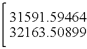 | 219.613304 |
| | | | | | 32163.509 | |
| 340483.2229 | 997.0715984 | 2.53765E-10 | 2.53765E-10 | 5.07529E-10 | 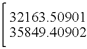 | 34.07580229 |
| | | | | | 35849.40903 | |
| 7080838.922 | 999.8587898 | 5.21591E-11 | 5.21591E-11 | 1.04318E-10 | 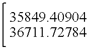 | 145.6537884 |
| | | | | | 36711.72785 | |

TABLE A 22

| NOTCH | | | | | | | |
|---|---|---|---|---|---|---|---|
| FREQUEN- | | NOTCH | | | | | |
| CIES | BAND- | CTR. | | CONDUCT- | CONDUCT- | CONDUCT- | FR. NRM. |
| (bold) | WIDTH | FREQ. | Q | ANCE (G1) | ANCE (G2) | ANCE (G3) | VAL (u) |
| 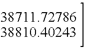 | 98.67457 | 38761.06515 | 372.8485213 | 745.0070426 | 0.001342107 | 745.0983847 | 230859.4891 |
| 38810.40244 | | | | | | | |
| 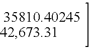 | 6862.91045 | 39241.85768 | 5.717961492 | 11.43592298 | 0.087443751 | 11.52338873 | 248438.8682 |
| IMP. | | | | | | | |
| SCALING | CAP. 1 | CAP. 2 | CAP. 3 | RESISTOR | RESISTOR | RESISTOR | R1 as |
| (ISF) | (C1) | (C2) | (C3) | 1 (R1) | 2 (R2) | 3 (R3) | MR1c |
| 585.3672794 | 7.39087E-09 | 7.59987E-09 | 1.47997E-08 | 0.785625557 | 436155.4287 | 0.765624142 | 1000 |
| 624.8703451 | 6.49383E-09 | 6.40583E-09 | 1.20877E-08 | 54.64100677 | 7145.069142 | 54.22638974 | 1000 |

What is claimed is:

1. A filter system for filtering an audio signal comprising:
an audio input signal;
a plurality of notch filters each having:
an input terminal, each input terminal electrically connected to each other;
an output terminal, each output terminal electrically connected to each other;
said plurality of notch filters having selected resistance and capacitance values corresponding to a frequency to be attenuated;
wherein each of said parallel connected notch filters have the same selected resistance and capacitance values so as to attenuate the same frequency.

2. The filter system according to claim 1 wherein said plurality of notch filters comprises up to ten parallel connected filters.

3. The filter system according to claim 1 wherein said plurality of notch filters comprises a first set of filters, said system further comprising:
a second set of parallel connected notch filters, said second set of parallel connected notch filters having selected resistance and capacitance values different from the resistance and capacitance values of the first set;
said second set of parallel connected notch filters connected in series with said first sect of parallel connected notch filters;
wherein each of said second set of parallel connected notch filters have the same selected resistance and capacitance values so as to attenuate the same frequency.

4. The filter system according to claim 3 wherein said second set of parallel connected notch filters comprises up to ten parallel connected filters.

5. The filter system according to claim 3 further comprising a third set of parallel connected notch filters connected in series with said second set of parallel connected notch filters;
wherein each of said third set of parallel connected notch filters have the same selected resistance and capacitance values so as to attenuate the same frequency.

6. The filter system according to claim 1 wherein said plurality of notch filters comprises a first set of filters, said system further comprising:
a second set of parallel connected notch filters, said second set of parallel connected notch filters having selected resistance and capacitance values different from the resistance and capacitance values of the first set;
said second set of parallel connected notch filters connected in parallel with said first sect of parallel connected notch filters;
wherein each of said second set of parallel connected notch filters have the same selected resistance and capacitance values so as to attenuate the same frequency.

7. The filter system according to claim 1 wherein each of said plurality of filters comprises an operational amplifier having an inverting and a non-inverting input.

8. The filter system according to claim 7 wherein each of said each of said plurality of filters comprises an input terminal and includes:
a capacitor (C₁) electrically connected to the input terminal and a capacitor (C₂) electrically connected to capacitor (C₁), said capacitor (C₂) electrically connected to the non-inverting input of said operational amplifier;
a resistor (R₁) electrically connected to the input terminal and a resistor (R₂) electrically connected to resistor (R₁), said resistor (R₂) electrically connected to the non-inverting input of said operational amplifier;
a capacitor (C₃) electrically connected to a point between resistor (R₁) and resistor (R₂) and a ground connection;
a resistor (R₃) electrically connected to a point between capacitor (C₁) and capacitor (C₂) and the inverting input of the operational amplifier.

9. The filter system according to claim 9 wherein the values for capacitors (C₁, C₂, C₃) and resistors (R₁, R₂, R₃) are selected from Table A to attenuate at least some of the frequency bands listed in Table A.

10. A filter system for filtering an audio signal including a plurality of parallel connected notch filters each of said plurality of filters having an input terminal and comprising:
a capacitor (C₁) electrically connected to the input terminal and a capacitor (C₂) electrically connected to capacitor (C₁), said capacitor (C₂) electrically connected to a non-inverting input of an operational amplifier;
a resistor (R₁) electrically connected to the input terminal and a resistor (R₂) electrically connected to resistor (R₁), said resistor (R₂) electrically connected to the non-inverting input of the operational amplifier;
a capacitor (C₃) electrically connected to a point between resistor (R₁) and resistor (R₂) and a ground connection;
a resistor (R₃) electrically connected to a point between capacitor (C₁) and capacitor (C₂) and the inverting input of the operational amplifier.

11. The filter system according to claim 10 wherein the values for capacitors (C₁, C₂, C₃) and resistors (R₁, R₂, R₃) are selected from Table A to attenuate at least some of the frequency bands listed in Table A.

12. A filter system for filtering an audio signal comprising:
a plurality of notch filters each of said plurality of filters having an input terminal and an output terminal;
said input terminals of said plurality of notch filters electrically connected to each other and said output terminal of said plurality of notch filters electrically connected to each other;
said plurality of notch filters each having selected resistance and capacitance values selected from Table A corresponding to a frequency to be attenuated;
wherein each of said parallel connected notch filters have the same selected resistance and capacitance values so as to attenuate the same frequency.

13. The filter system according to claim 12 wherein said plurality of notch filters comprises a first set of filters, said system further comprising:
a second set of parallel connected notch filters, said second set of parallel connected notch filters having resistance and capacitance values selected from Table A;
said resistance and capacitance values of said second set of parallel connected notch filters being different from the resistance and capacitance values of the first set of parallel connected notch filters;
said second set of parallel connected notch filters connected in series with said first sect of parallel connected notch filters;
wherein each of said second set of parallel connected notch filters have the same selected resistance and capacitance values so as to attenuate the same frequency.

14. The filter system according to claim 13 further comprising a third set of parallel connected notch filters connected in series with said second set of parallel connected notch filters;
said third set of parallel connected notch filters having resistance and capacitance values selected from Table A;
said resistance and capacitance values of said third set of parallel connected notch filters being different from the resistance and capacitance values of the first and second set of parallel connected notch filters.

15. A filter system for filtering an audio signal comprising:
a plurality of parallel connected notch filters having selected resistance and capacitance values corresponding to a frequency to be attenuated;
wherein each of said parallel connected notch filters has the same selected resistance and capacitance values so as to attenuate the same frequency.

16. The filter system according to claim 15 wherein said plurality of notch filters comprises up to ten parallel connected filters.

17. The filter system according to claim 15 wherein said plurality of notch filters comprises a first set of filters, said system further comprising:
a second set of parallel connected notch filters, said second set of parallel connected notch filters having selected resistance and capacitance values different from the resistance and capacitance values of the first set;
said second set of parallel connected notch filters connected in series with said first sect of parallel connected notch filters;
wherein each of said second set of parallel connected notch filters have the same selected resistance and capacitance values so as to attenuate the same frequency.

18. The filter system according to claim 17 further comprising a third set of parallel connected notch filters connected in series with said second set of parallel connected notch filters;
wherein each of said third set of parallel connected notch filters have the same selected resistance and capacitance values so as to attenuate the same frequency.

19. The filter system according to claim 15 wherein each of said plurality of filters comprises an operational amplifier having an inverting and a non-inverting input.

20. The filter system according to claim 19 wherein each of said each of said plurality of filters comprises an input terminal and includes:
a capacitor (C₁) electrically connected to the input terminal and a capacitor (C₂) electrically connected to capacitor (C₁), said capacitor (C₂) electrically connected to the non-inverting input of said operational amplifier;
a resistor (R₁) electrically connected to the input terminal and a resistor (R₂) electrically connected to resistor (R₁), said resistor (R₂) electrically connected to the non-inverting input of said operational amplifier;
a capacitor (C₃) electrically connected to a point between resistor (R₁) and resistor (R₂) and a ground connection;
a resistor (R₃) electrically connected to a point between capacitor (C₁) and capacitor (C₂) and the inverting input of the operational amplifier.

21. The filter system according to claim 20 wherein the values for capacitors (C₁, C₂, C₃) and resistors (R₁, R₂, R₃) are selected from Table A to attenuate at least some of the frequency bands listed in Table A.

22. A method for filtering an audio signal comprising the steps of:
identifying a bandwidth of audio frequencies;
identifying a plurality of frequency bands to be attenuated within the bandwidth of audio frequencies;
electrically connecting a plurality of sets of audio filters in series;
inputting the audio signal into the plurality of sets of audio filters;
attenuating the plurality of identified frequency bands; and
outputting the filtered audio signal from the plurality of sets of audio filters.

23. The method of claim 22 wherein each set of audio filters comprises individual parallel connected audio filters.

24. The method of claim 23 wherein each audio filter is formed according to the following steps:
electrically connecting a capacitor (C₁) between an input terminal and a capacitor (C₂);
electrically connecting capacitor (C₂) between capacitor (C₁) and a non-inverting input of an operational amplifier;
electrically connecting a resistor (R₁) between the input terminal and a resistor (R₂);
electrically connecting resistor (R₂) between resistor (R₁) and the non-inverting input of an operational amplifier;
electrically connecting a capacitor (C₃) to a point between resistor (R₁) and resistor (R₂) and a ground connection;
electrically connecting a resistor (R₃) to a point between capacitor (C₁) and capacitor (C₂) and an inverting input of the operational amplifier.

25. The method of claim 24 further comprising the steps of selecting values for capacitors (C₁, C₂, C₃) and resistors (R₁, R₂, R₃) from Table A to attenuate at least some of the frequency bands listed in Table A.
